(19) United States
(12) Patent Application Publication
(10) Pub. No.: US 2022/0208423 A1
(43) Pub. Date: Jun. 30, 2022

(54) SOFT MAGNETIC ALLOY POWDER, DUST CORE, MAGNETIC COMPONENT AND ELECTRONIC DEVICE

(71) Applicant: TDK CORPORATION, Tokyo (JP)

(72) Inventors: Kazuhiro YOSHIDOME, Tokyo (JP); Hiroyuki MATSUMOTO, Tokyo (JP); Akito HASEGAWA, Tokyo (JP); Hironobu KUMAOKA, Tokyo (JP)

(73) Assignee: TDK CORPORATION, Tokyo (JP)

(21) Appl. No.: 17/602,157

(22) PCT Filed: Apr. 22, 2020
(86) PCT No.: PCT/JP2020/017329

§ 371 Date: Oct. 7, 2021

(30) Foreign Application Priority Data
Apr. 25, 2019 (JP) 2019-084663
Apr. 21, 2020 (JP) 2020-075690

(51) Int. Cl. H01F 1/153; C22C 38/12; C22C 38/10; C22C 38/02; C22C 38/00; B22F 1/052

(52) U.S. Cl. CPC H01F 1/15325; C22C 38/12; C22C 38/105; C22C 38/02; B22F 2301/35; B22F 1/052; C22C 2202/02; C22C 2200/02; B22F 2304/10; C22C 38/002

(57) ABSTRACT

A soft magnetic alloy powder which is a soft magnetic alloy powder having a low coercivity, and with which it is possible to obtain a green compact magnetic core having a high magnetic permeability. A soft magnetic alloy powder including a composition formula (Fe(1−(α+β))X1 αX2 β) (1−(a+b+c+d+e+f)) MaBbPcSidCeSf. XI is one or more elements selected from the group consisting of Co and Ni, X2 is one or more elements selected from the group consisting or Al, Mn, Ag, Zn, Sn, As, Sb, Cu, Cr, Bi, N, O and rare earth elements, and M is one or more elements selected from the group consisting of Nb, Hf, Zr, Ta, Mo, W, Ti and V. The amount of each component contained is within a specified range. The amorphous rate X (%) is at least 85%.

### TECHNICAL FIELD

The present invention relates to a soft magnetic alloy powder, a dust core, a magnetic component, and an electronic device.

### BACKGROUND

Patent Document 1 discloses a composite magnetic material obtained by mixing an insulation binder with a mixed magnetic powder in which an iron-based crystal magnetic powder and an iron-based amorphous magnetic powder are mixed.

Patent Document 2 discloses a composite magnetic material in which a heat curing-agent is coated on each particle included in a mixed magnetic powder obtained by mixing a Fe—Ni based alloy magnetic powder with a hard amorphous alloy magnetic powder.

### [Patent Document 1] JP Patent Application Laid Open No. 2004-197218

### [Patent Document 2] JP Patent Application Laid Open No. 2004-363466

### SUMMARY

The object of the present invention is to provide a soft magnetic alloy powder having a low coercivity, and also to provide the soft magnetic alloy powder capable of obtaining a dust core having a high permeability.

In order to achieve the above-mentioned object, a soft magnetic alloy powder according to the present invention is represented by a compositional formula (Fe_{(1-(α+β))}X1_{α}X2_{β})_{(1-(a+b+c+d+e+f))}MₐB_{b}P_{c}Si_{d}CₑS_{f}, wherein

X1 is one or more selected from the group consisting of Co and Ni;

X2 is one or more selected from the group consisting of Al, Mn, Ag, Zn, Sn, As, Sb, Cu, Cr, Bi, N, O, and rare earth elements;

M is one or more selected from the group consisting of Nb, Hf, Zr, Ta, Mo, W, Ti, and V;

0≤a≤0.150,

0≤b≤0.200,

0≤c≤0.200,

0≤d≤0.200,

0<e≤0.200,

0<f≤0.0200,

0.100≤a+b+c+d+e≤0.300,

0.0001≤e+f≤0.220,

α≥0,

β≥0, and

0≤α+β≤0.50 are satisfied; and

an amorphous ratio (X) represented by a below formula (1) satisfies 85% or more.

X=100−(Ic/(Ic+Ia))×100 (1)

Ic: Crystal scattering integrated intensity

Ia: Amorphous scattering integrated intensity

By having the above-described characteristics, the soft magnetic alloy powder according to the present invention achieves sufficiently low coercivity HcJ. Further, by using the soft magnetic alloy powder according to the present invention, a dust core and the like having a high permeability can be obtained.

In the soft magnetic alloy powder according to the present invention, D50 of a volume-based particle size distribution is represented by r, and soft magnetic alloy particles having particle sizes of r or more and 2r or less of the soft magnetic alloy powder may have an average circularity of 0.70 or more.

In the soft magnetic alloy powder according to the present invention, D50 of a volume-based particle size distribution is represented by r, soft magnetic alloy particles having particle sizes of r or more and 2r or less of the soft magnetic alloy powder may have an average circularity of 0.90 or more.

In the soft magnetic alloy powder according to the present invention, soft magnetic alloy particles having particle sizes of 25 μm or more and 30 μm or less of the soft magnetic alloy powder may have an average circularity of 0.70 or more.

In the soft magnetic alloy powder according to the present invention, soft magnetic alloy particles having particle sizes of 25 μm or more and 30 μm or less of the soft magnetic alloy powder may have an average circularity of 0.90 or more.

In the soft magnetic alloy powder according to the present invention, soft magnetic alloy particles having particle sizes of 5 μm or more and 10 μm or less of the soft magnetic alloy powder may have an average circularity of 0.70 or more.

In the soft magnetic alloy powder according to the present invention, soft magnetic alloy particles having particle sizes of 5 μm or more and 10 μm or less of the soft magnetic alloy powder may have an average circularity of 0.90 or more.

The soft magnetic alloy powder according to the present invention may satisfy 0.0001≤e+f≤0.051.

The soft magnetic alloy powder according to the present invention may satisfy 0.080<d<0.100.

The soft magnetic alloy powder according to the present invention may satisfy 0.030<e≤0.050.

The soft magnetic alloy powder according to the present invention may satisfy 0≤a<0.020.

The soft magnetic alloy powder according to the present invention may include nanocrystal particles.

A dust core according to the present invention includes the above-mentioned soft magnetic alloy powder.

A magnetic component according to the present invention includes the above-mentioned soft magnetic alloy powder.

An electronic device according to the present invention includes the above-mentioned soft magnetic alloy powder.

### BRIEF DESCRIPTION OF THE DRAWINGS

FIG. 1 is an example of a chart obtained by X ray crystallography.

FIG. 2 is an example of a pattern obtained by profile fitting the chart of FIG. 1.

FIG. 3 is a graph showing a particle size distribution.

FIG. 4 is a graph showing a particle size distribution.

FIG. 5 is an observation result by a Morphologi G3.

FIG. 6A is a schematic diagram of an atomization apparatus.

FIG. 6B is a schematic diagram of which an essential part of FIG. 6A has been enlarged.

### DETAILED DESCRIPTION

Hereinafter, embodiments of the present invention are described.

In order to achieve the above-mentioned object, a soft magnetic alloy powder according to the present embodiment is represented by a compositional formula (Fe_{(1-(α+β))}X1_{α}X2_{β})_{(1-(a+b+c+d+e+f))}MₐB_{b}P_{c}Si_{d}CₑS_{f}, wherein

X1 is one or more selected from the group consisting of Co and Ni;

X2 is one or more selected from the group consisting of Al, Mn, Ag, Zn, Sn, As, Sb, Cu, Cr, Bi, N, O, and rare earth elements;

M represents one or more selected from the group consisting of Nb, Hf, Zr, Ta, Mo, W, Ti, and V:

0≤a≤0.150,

0≤b≤0.200,

0≤c≤0.200,

0≤d≤0.200,

0<e≤0.200,

0<f≤0.0200.

0.100≤a+b+c+d+e≤0.300,

0.0001≤e+f≤0.220,

α≥0,

β≥0, and

0≤α+β≤0.50 are satisfied; and

an amorphous ratio (X) represented by a below formula (1) satisfies 85% or more.

X=100−(Ic/(Ic+Ia))×100 (1)

Ic: Crystal scattering integrated intensity

Ia: Amorphous scattering integrated intensity

By satisfying the above-described characteristics, the soft magnetic alloy powder according to the present embodiment achieves a sufficiently low coercivity HcJ. Further, a broad particle size distribution tends to be easily obtained. As a result, by using the soft magnetic alloy powder according to the present embodiment, a dust core and the like having a high permeability μ can be obtained. Further, the soft magnetic alloy powder having a particle size within a specific range has a higher circularity. As a result, the soft magnetic alloy powder having even better HcJ can be obtained. Also, a dust core and the like having even higher permeability μ can be obtained.

Hereinafter, each component of the soft magnetic alloy powder according to the present invention is described in detail.

M is at least one selected from the group consisting of Nb, Hf, Zr, Ta, Mo, W, Ti, and V.

M amount (a) is within a range of 0≤a≤0.150. That is, the soft magnetic alloy powder according to the present embodiment may not include M. From the point of decreasing HcJ, preferably M amount (a) may be within a range of 0≤a≤0.070. As M amount (a) increases, a saturation magnetization tends to easily decrease.

M amount (a) may be within a range of 0≤a<0.020; and may be within a range of 0≤a≤0.019. When M amount (a) is within the above-mentioned range, the saturation magnetization may be further improved.

B amount (b) is within a range of 0≤b≤0.200. That is, the soft magnetic alloy powder according to the present embodiment may not include B. Also, B amount (b) may be within a range of 0.060≤b≤0.200. When B amount (b) is too large, the saturation magnetization tends to easily decrease.

P amount (c) is within a range of 0≤c≤0.200. That is the soft magnetic alloy powder according to the present embodiment may not include P. Also, P amount (c) may be within a range of 0≤c≤0.150. When P amount (c) is too large, as similar to the case when B amount (b) is too large, the saturation magnetization tends to easily decrease.

Si amount (d) is within a range of 0≤d≤0.200. That is, the soft magnetic alloy powder according to the present embodiment may not include Si. Si amount (d) may be within a range of 0.080<d<0.100, and may be within a range of 0.085≤d≤0.095. When Si amount (d) is too large, a circularity of the soft magnetic alloy powder tends to easily decrease.

C amount (e) is within a range of 0<e≤0.200. That is, the soft magnetic alloy powder according to the present embodiment always include C. Also, C amount (e) may be within a range of 0.001≤e≤0.150, and may be 0.030<e≤0.050. By including C in the soft magnetic alloy powder according to the present embodiment, HcJ tends to easily decrease. When C amount (e) is too large, as similar to the case when B amount (b) is too large and P amount (c) is too large, the saturation magnetization tends to easily decrease.

S amount (f) is within a range of 0<f≤0.0200. That is, the soft magnetic alloy powder according to the present embodiment always include S. Also, S amount (f) may be within a range of 0.0001≤f≤0.0200. By including S in the soft magnetic alloy powder according to the present embodiment, a broad particle size distribution can be easily formed, and a permeability μ of the dust core and the like produced by using the soft magnetic alloy powder tends to easily increase. Note that, when the soft magnetic alloy powder according to the present embodiment does not include C and includes S, HcJ tends to become too large. Also, the permeability μ of the dust core and the like tends to decrease easily. When S amount (f) is too large, the soft magnetic alloy powder tends to easily include crystal grains having crystal grain sizes of larger than 100 nm. Further, when the soft magnetic alloy powder includes the crystal grains having a crystal grain size of larger than 100 nm, HcJ tends to increase significantly, and the permeability μ of the dust core and the like using the soft magnetic alloy powder tends to decrease easily.

Also, the soft magnetic alloy powder according to the present embodiment satisfies 0.100≤a+b+c+d+e≤0.300. Further, the soft magnetic alloy powder according to the present embodiment may satisfy 0.240≤a+b+c+d+e≤0.300. As a+b+c+d+e is within the above-mentioned ranges, various properties tend to easily improve. When a+b+c+d+e is too small, the soft magnetic alloy powder tends to easily include crystal grains having crystal grain sizes of larger than 100 nm. When a+b+c+d+e is too large, the saturation magnetization tends to easily decrease.

Also, in the soft magnetic alloy powder according to the present invention, 0.0001≤e+f≤0.220 is satisfied. Further, the soft magnetic alloy powder according to the present embodiment may satisfy 0.0001≤e+f≤0.051. When e+f is within the above-mentioned ranges, various properties tend to easily improve.

According to the above, among C and S, when C is only included and S is not included in the soft magnetic alloy powder, a sharper particle size distribution is obtained. As a result, an improved HcJ is obtained, however the permeability μ of the dust core and the like using the soft magnetic alloy powder cannot be improved. Among C and S, when S is only included and C is not included, HcJ tends to deteriorate, and the dust core and the like using the soft magnetic alloy powder has only a small improvement in the permeability μ. Also, when C and S both are included but e+f is too large, the soft magnetic alloy powder tends to easily include crystal grains having crystal grain sizes of larger than 100 nm.

Fe amount (1−(a+b+c+d+e+f)) is not particularly limited, and Fe amount may be within a range of 0.699≤1−(a+b+c+d+e+f)≤0.8999. By having 1−(a+b+c+d+e+f) within this range, crystal grains having crystal grain sizes of larger than 100 nm are rarely found in the soft magnetic alloy powder. Also, Fe amount (1−(a+b+c+d+e+f)) may be 0.740 or more. By having 0.740 or more of Fe amount (1−(a+b+c+d+e+f)), the saturation magnetization tends to easily increase.

Also, in the soft magnetic alloy powder according to the present embodiment, Fe may be partially substituted by X1 and/or X2.

X1 is one or more selected from the group consisting of Co and Ni. Regarding X1 amount, it may be α=0. That is, X1 may not be included. Also, the number of X1 atoms may be 40 at % or less when the number of atoms included in the composition as a whole is 100 at %. That is, 0≤α{1−(a+b+c+d+e+f)}≤0.400 may be satisfied.

X2 is at least one selected from the group consisting of Al, Mn, Ag, Zn, Sn, As, Sb, Cu, Cr, Bi, N, O, and rare earth elements. Also, particularly from the point of decreasing HcJ, X2 may be at least one selected from the group consisting of Al, Zn, Sn, Cu, Cr, and Bi. X2 amount may be β=0. That is, X2 may not be included. Also, the number of X2 atoms may be 3.0 at % or less when the number of atoms included in the composition as a whole is 100 at %. That is, 0≤β{1−(a+b+c+d+e+f)}≤0.030 may be satisfied.

A substitution amount of Fe with X1 and/or X2 may be half or less of Fe in terms of the number of atoms. That is, it may be within a range of 0≤α+β≤0.50.

Note that, the soft magnetic alloy powder may include elements as the inevitable impurities other than the above-mentioned elements. For example, 0.1 wt % or less of inevitable impurities may be included with respect to 100 wt % of the soft magnetic alloy powder.

Also, the soft magnetic alloy powder according to the present embodiment has a structure made of amorphous. Specifically, an amorphous ratio X shown by the below formula (1) is 85% or more.

X=100−(Ic/(Ic+Ia))×100 (1)

Ic: Crystal scattering integrated intensity

Ia: Amorphous scattering integrated intensity

The soft magnetic alloy powder having a high amorphous ratio X tends to have a small magnetocrystalline anisotropy. Therefore, the dust core using the soft magnetic alloy powder having a high amorphous ratio X tends to have a small magnetic loss.

X ray crystallography is performed to the soft magnetic alloy powder using XRD, and phases are identified to read peaks of crystallized Fe or compounds (Ic: Crystal scattering integrated intensity, Ia: Amorphous scattering integrated intensity). Then, a crystallization ratio is determined from these peaks, and the amorphous ratio is calculated from the above-mentioned formula (1). In below, the method of calculation is described in further detail.

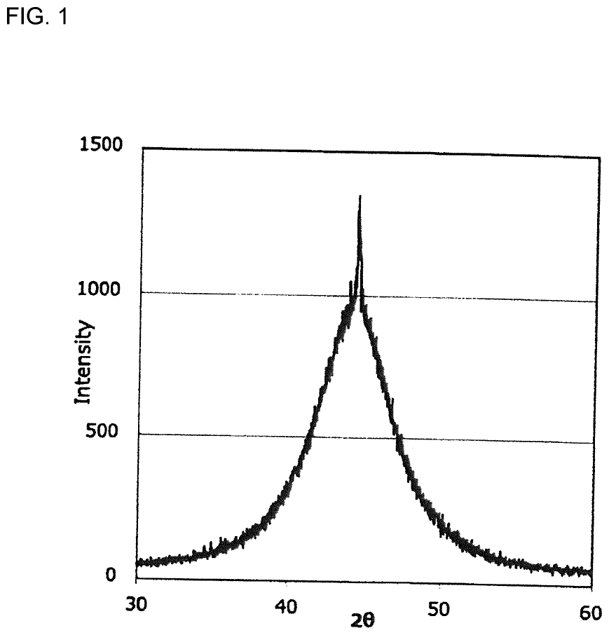

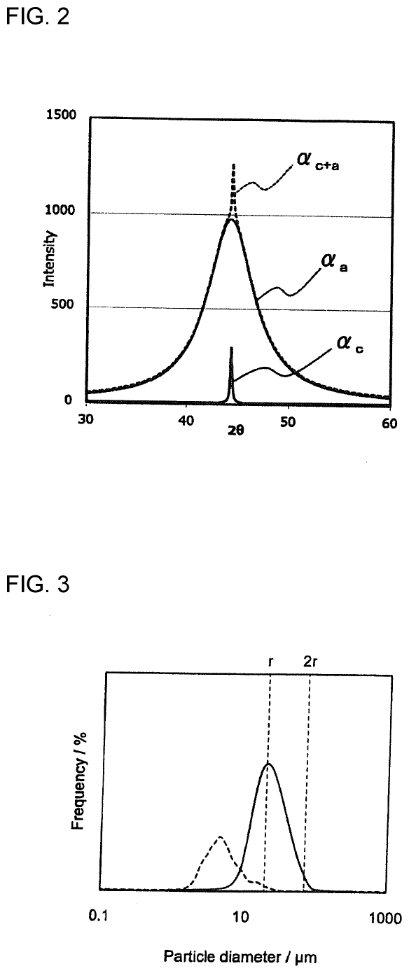

Regarding the soft magnetic alloy powder according to the present embodiment, X ray crystallography is performed by XRD to obtain a chart shown in FIG. 1. Then, profile fitting is performed to this chart using a Lorenz function shown by the formula (2). Thereby, as shown in FIG. 2, a crystal component pattern α_{c} which indicates a crystal scattering integrated intensity, an amorphous component pattern αₐ which indicates an amorphous scattering integrated intensity, and a pattern α_{c+a} which is a combination of these are obtained. According to the obtained crystal scattering integrated intensity pattern and the amorphous scattering integrated intensity pattern, the amorphous ratio X is obtained using the above-mentioned formula (1). Note that, as a range of measurement, the range is within a diffraction angle of 2θ=30° to 60° in which a halo derived from amorphous can be confirmed. Within this range, a difference between the integrated intensity obtained from actual measurement by XRD and the integrated intensity calculated using a Lorenz function is set within 1%.

$$[ Formula 1 ]$$

$$f ( x ) = \frac{h}{1 + \frac{{( x - u )}^{2}}{{w}^{2}}} + b \qquad ( 2 )$$

h: Peak height
u: Peak position
w: Half bandwidth
b: Background height

Note that, the soft magnetic alloy powder according to the present embodiment may include nanocrystal particles as long as the amorphous ratio X (%) is 85%. A nanocrystal particle is a particle including a nanocrystal grain having a crystal grain size of 50 nm or less. Also, XRD can be used to verify whether the nanocrystal particles are included in the soft magnetic alloy powder. When the soft magnetic alloy powder includes the nanocrystal particles, HcJ tends to decrease even more easily, and the permeability μ of the dust core and the like using the soft magnetic alloy powder tends to easily increase.

Note that, the nanocrystal particles usually include many nanocrystal grains. That is, the particle size of the soft magnetic alloy powder described in below and the crystal grain sizes of the nanocrystal grains are different.

Also, the soft magnetic alloy powder according to the present embodiment may be a soft magnetic alloy powder having a high sphericity. By having the above-mentioned composition, the soft magnetic alloy powder having a particle shape close to sphere, in other words, the soft magnetic alloy powder having a high sphericity can be obtained.

In general, as amorphous ratio X of the soft magnetic alloy powder increases, a plastic deformation tends to less likely occur. Thus, a packing density tends to become difficult to increase during compacting of the dust core and the like. By making the particle shape of the soft magnetic alloy powder close to sphere, the packing density of the dust core and the like using the soft magnetic alloy powder can be increased, and various properties such as a coercivity HcJ, a permeability μ, and the like can be improved.

Further, in the soft magnetic alloy powder according to the present embodiment, the sphericity of the powder having a large particle size is preferably high. As the powder having a large particle size has a high sphericity, the packing density of the dust core and the like using the soft magnetic alloy powder can be further increased, and a permeability μ tends to easily increase.

Hereinbelow, a method of evaluating a particle shape and a particle size (particle size distribution) of the soft magnetic alloy powder according to the present embodiment is described.

As described in above, the packing density of the dust core and the like using the soft magnetic alloy powder can be improved as the particle shape is closer to sphere, and various properties such as coercivity can be improved.

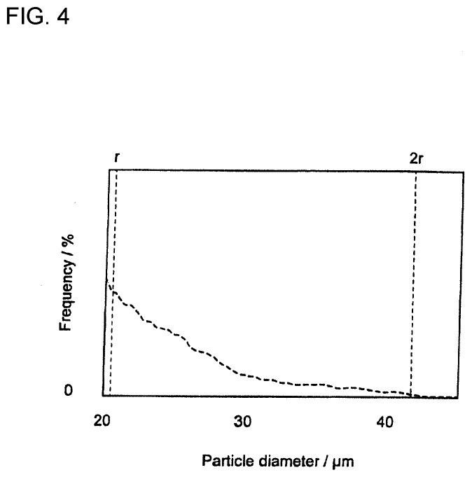

In general, as for the particle size distribution of the soft magnetic alloy powder, a volume-based particle size distribution and a number-based particle size distribution may be mentioned. The volume-based particle size distribution is shown by a graph in which a particle size is on a bilateral axis and a volume-based frequency is on a vertical axis. The number-based particle size distribution is shown by a graph in which a particle size is on a bilateral axis and a number-based frequency is on a vertical axis. When these two graphs are overlayed on each other, for example, a graph shown in FIG. 3 may be obtained. In FIG. 3, a bold line shows the volume-based particle size distribution and a broken line shows the number-based particle size distribution. FIG. 3 shows positions of r and 2r in which r is a volume-based D50 of the particle size.

The difference between the volume-based particle size distribution and the number-based particle size distribution is how each particle is reflected to the data. In the volume-based particle size distribution, each particle reflected to the data is proportional to volume of particle. That is, a small-sized particle reflected to the data becomes small. On the other hand, in the number-based particle size distribution, each small-sized particle is reflected to the data in the same level. That is, in the number-based particle size distribution, more small-sized particles are reflected to the data. Thus, the volume-based particle size distribution and the number-based particle size differ.

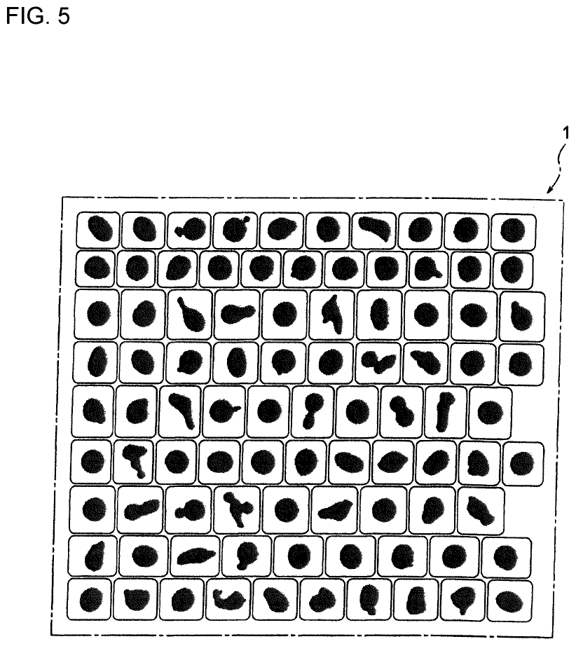

As mentioned in above, in the soft magnetic alloy powder according to the present embodiment, the powder having a large particle size preferably has a high sphericity. Specifically, a number-based average circularity of the particles having the particle sizes of r or more and 2r or less may be 0.70 or more, and it may be 0.90 or more. A number-based amount ratio of the particles having the particle sizes of r or more and 2r or less may be 1% or more and 25% or less with respect to the soft magnetic alloy powder as a whole. Note that, FIG. 4 shows a part of the number-based particle size distribution which is a particle size distribution satisfying the particle sizes of r or more and 2r or less excerpted from the number-based particle size distribution.

In the soft magnetic alloy powder according to the present embodiment, a number-based average circularity of particles having particle sizes 25 μm or more 30 μm or less may be 0.70 or more, or 0.90 or more. In this case, a number-based D50 of the particle sizes may be 0.5 μm or more and 25 μm or less. Also, a number-based amount ratio of the particles having particle sizes of 25 μm or more and 30 μm or less may be 0.1% or more and 10% or less with respect to the soft magnetic alloy powder as a whole.

In the soft magnetic alloy powder according to the present embodiment, a number-based average circularity of particles having particle sizes of 5 μm or more and 10 μm or less may be 0.70 or more, and 0.90 or more. In this case, a number-based D50 of the particle sizes may be 0.5 μm or more and 5 μm or less. Also, a number-based amount ratio of the particles having particle sizes of 5 μm or more 10 μm or less may be 0.1% or more and 10% or less with respect to the soft magnetic alloy powder as a whole.

In the present embodiment, an evaluation method of a volume-based particle size distribution and a volume-based D50 (r) of the particle sizes is not particularly limited. For example, evaluation may be performed by a laser diffraction particle size distribution analyzer which uses a diffraction theory by Fraunhofer.

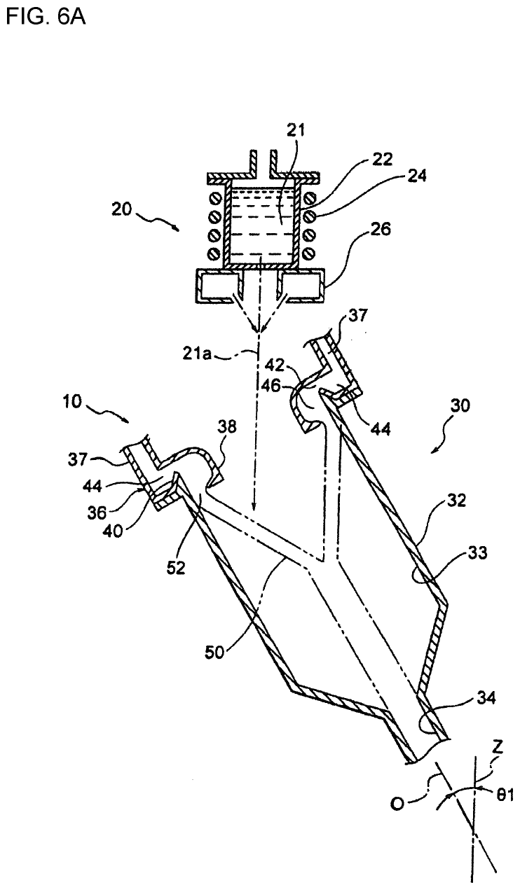

In the present embodiment, the number-based particle size distribution and the like are evaluated using a Morphologi G3 (made by Malvern Panalytical Ltd). A Morphologi G3 is a device which disperses the powder by air, and a shape of individual particle is projected, thereby evaluation can be carried out. The particle shape having a particle size approximately within a range of 0.5 μm to several mm by an optical microscope or a laser microscope can be evaluated by a Morphologi G3. Specifically, as understood from the measurement results of the particle shape shown in FIG. 5, shapes of multiple particles can be projected in one time and evaluated. In reality, particle shapes of significantly larger numbers of particles than those of the measurement results of the particle shapes shown in FIG. 5 can be projected at one time and evaluated.

Since a Morphologi G3 can make a projection of many particles at one time for evaluation, shapes of many particles can be evaluated in short time compared to a conventional evaluation method such as SEM observation and the like. For example, in Examples described in below, projections of 2000 particles are produced, and a particle size and a circularity of each particle is automatically calculated, and an average circularity of the particles having particle sizes within a predetermined range is calculated. On the contrary to this, in a conventional SEM observation, a circularity of each one of the particles is calculated using the SEM image, thus it is difficult to evaluate shapes of large numbers of particles in a short time.

The circularity of the particle is represented by 4πS/L², in which S is an area of a projection and L is a length of circumference of the projection. The circularity of a circle is 1, and as the circularity of the particle projection becomes closer to 1, a sphericity of the particle increases.

Also, whether the soft magnetic alloy powder according to the present embodiment has a broad particle size distribution is evaluated by a number-based standard deviation a of the particle sizes.

Note that, in case of evaluating various particle size distributions of the soft magnetic alloy powder included in the dust core and the like, a conventional method by SEM observation can be used. For each and one of particles included in an arbitrary cross section of the dust core and the like, a particle size and a circularity may be calculated and evaluated from the SEM image.

The present inventors have found that the soft magnetic alloy powder having a broad particle size distribution can be obtained by controlling the composition of the soft magnetic alloy powder. Also, HcJ of the soft magnetic alloy powder as a whole can be controlled by regulating the composition of the soft magnetic alloy powder.

Also, the present inventors have found that the dust core and the like having a good permeability μ can be obtained when the dust core and the like uses the soft magnetic alloy powder as a whole has a good HcJ and a broad particle size distribution.

Also, in order to further improve HcJ of the soft magnetic alloy powder as a whole; and also to improve the permeability μ, a voltage resistance, and the like of the dust core and the like using the soft magnetic alloy powder, the present inventors have found that it is more important to control a sphericity of the soft magnetic alloy powder having a large particle size than to control a sphericity of the soft magnetic alloy powder as a whole. Specifically, as the number-based average circularity of the particles having the particle sizes of r or more and 2r or less increases and also as the number-based average circularity of the particles having particles sizes of 25 μm or more and 30 μm or less increases, good permeability μ and voltage resistance property tend to easily obtained.

Note that, the sphericity of the soft magnetic alloy powder as a whole can be varied by controlling a method of production. However, even if only the method of production is controlled, the sphericity of the particles of the soft magnetic alloy powder having large particle sizes is difficult to change than to change the sphericity of the particles of the soft magnetic alloy powder having small particle sizes. That is, in order to control the sphericity of the particles of the soft magnetic alloy powder having large particle sizes, it is important to control the composition of the soft magnetic alloy powder so that the particle shapes of the soft magnetic alloy powder as a whole can be easily changed by the method of production.

Here, regarding a volume distribution of the soft magnetic alloy powder as a whole, the soft magnetic alloy powder having a small particle size and the soft magnetic alloy powder having a large particle size both having the same total volume ratios are compared. When the total volume ratios are the same, the soft magnetic alloy powder having a small particle size has significantly larger numbers of particles compared to the soft magnetic alloy powder having large particle sizes. For example, when the total volume ratios are the same, the number of particles of the soft magnetic alloy powder having the particle sizes of 10 μm is about 1/1000 of the number of particles of the soft magnetic alloy powder having the particle sizes of 1 μm.

That is, the sphericity of the soft magnetic alloy powder as a whole has only a small influence on the sphericity of the soft magnetic alloy powder having a large particle size which is a small number of particles in the soft magnetic alloy powder. Further, regardless of the sphericity of the soft magnetic alloy powder having a large particle size, the sphericity of the soft magnetic alloy powder as a whole can be changed.

Hereinafter, a method of production of the soft magnetic alloy powder according to the present embodiment is described.

The method of production of the soft magnetic alloy powder according to the present embodiment is not particularly limited. For example, an atomization method may be mentioned. A type of the atomization method is not particularly limited, and a water atomization method, a gas atomization method, and the like may be mentioned.

Hereinafter, the method of production of the soft magnetic alloy powder using a water atomization method is described. First, raw materials are prepared. The prepared raw materials may be simple metals and the like, or may be alloys. A form of the raw materials is not particularly limited. For example, ingot, chunk (bulk), or shot (particle) may be mentioned.

Next, the prepared raw materials are weighed and mixed. At this point, the raw materials are weighed so that the soft magnetic alloy powder having a composition at the end can be obtained. Then, the mixed raw materials are melted and mixed to obtain a molten metal. An apparatus used for melting and mixing is not particularly limited. For example, a crucible and the like may be used. A temperature of the molten metal may be determined according to a melting point of each metal element, and for example, the temperature can be 1200° C. to 1600° C.

Then, the soft magnetic alloy powder is produced from the molten metal by a water atomization method. Specifically, the molten metal is sprayed out by a nozzle and the like, and a high-pressured water stream is collided to the sprayed molten metal for quenching, then the soft magnetic alloy powder can be produced. Note that, the composition of the molten metal and the composition of the soft magnetic alloy powder are substantially the same.

Here, in order to obtain the soft magnetic alloy powder having a desired particle size, the particle size can be controlled for example by regulating a pressure of the high-pressured water stream, and an amount of the molten metal sprayed out. Thereby, the soft magnetic alloy powder having a desired particle size distribution can be obtained.

The pressure of the high-pressured water stream for example may be 50 MPa or more and 100 MPa or less. The amount of the molten metal sprayed out for example may be 1 kg/min or more and 20 kg/min or less.

Also, the obtained soft magnetic alloy powder which is amorphous may be heat treated to precipitate nanocrystal particles in the soft magnetic alloy powder. For example, a condition of the heat treatment may be 350° C. or higher and 800° C. or lower for 0.1 minute or longer and 120 minutes or less.

Hereinafter, a method of production of the soft magnetic alloy powder using a gas atomization method is described.

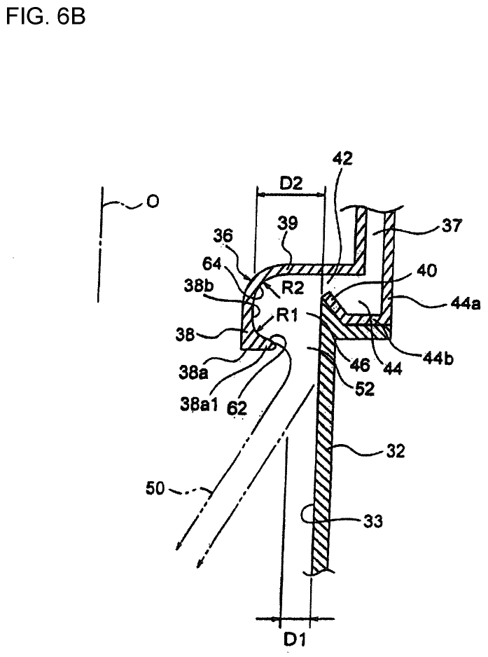

The present inventors have found that when an atomization apparatus shown in FIG. 6A and FIG. 6B is used as an atomization apparatus, the soft magnetic alloy powder having a larger particle size can be produced easily, and the amorphous soft magnetic alloy powder can be obtained easily.

As shown in FIG. 6A, the atomization apparatus 10 includes a molten metal supplier 20, and a cooling part 30 provided at lower side in vertical direction of the molten metal supplier 20. In the figures, the vertical direction is a direction along Z axis.

The molten metal supplier 20 includes a heat resistant container 22 which holds the molten metal 21. In the heat resistant container 22, the raw material of each metal element which has been weighed so to obtain the composition of the soft magnetic alloy powder obtained at the end is melted by a heating coil 24 and forms the molten metal 21. A temperature during melting, that is, the temperature of the molten metal 21 may be determined according to the melting point of the raw material of each metal element, and for example the temperature can be within a range of 1200° C. to 1600° C.

The molten metal 21 is exhausted as a molten metal drop 21a from an exhaust port 23 towards cooling part 30. A high-pressured gas is sprayed from a gas spraying nozzle 26 towards the exhausted molten metal drop 21a to form many droplets from the molten metal drop 21a, then the droplets move along with the gas flow towards an inner surface of a cylinder 32.

As a gas sprayed from the gas spraying nozzle 26, inert gas or reducing gas is preferable. As the inert gas, for example, nitrogen gas, argon gas, helium gas, and the like can be used. As the reducing gas, for example, ammonia decomposition gas can be used. However, in case the molten metal 21 is a metal which is difficult to oxidize, the gas sprayed from the gas spraying nozzle 26 may be air.

The molten metal drop 21a moving towards the inner surface of the cylinder 32 collides with a coolant flow 50 formed in an inverted cone shape at the inside of the cylinder 32, then the molten metal drop 21a becomes even smaller and finer size and the alloy powder of solid form is obtained by cool solidifying. A center axis O of the cylinder 32 is tilted by a predetermined angle θ1 with respect to a vertical line Z. The predetermined angle θ1 is not particularly limited and preferably it is 0 to 45 degrees. By having the predetermined angle θ1 within such range, the molten metal drop 21a from the exhaust port 23 can be easily exhausted towards the coolant flow 50 which is formed in an inverted cone shape at the inside of the cylinder 32.

At a lower side along the center axis O of the cylinder 32, a discharge port 34 is provided and the alloy powder included in the coolant flow 50 can be discharged together with the coolant to outside. The alloy powder discharged together with the coolant flow is separated from the coolant in an external storage tank or so, then the alloy powder is taken out. Note that, the coolant is not particularly limited, and for example a cooling water may be used.

In the present embodiment, the molten metal drop 21a collides against the coolant flow 50 formed in an inverted cone shape, thus the length of time of the droplets of the molten metal drop in the air can be shortened compared to the case where the coolant flow is moving along the inner face 33 of the cylinder 32. By shortening the length of time in the air, a quenching effect can be enhanced, and the amorphous ratio X of the obtained soft magnetic alloy powder can be improved. Further, the sphericity of the soft magnetic alloy powder having a large particle size tends to increase easily. Also, by shortening the length of time in the air, the droplets of the molten metal drop 21a becomes difficult to oxidize, and the obtained soft magnetic alloy powder can be made smaller efficiently, and quality of the soft magnetic alloy powder is improved.

In the present embodiment, in order to form the coolant flow of an inverted cone shape at the inside of the cylinder 32, a flow of the coolant at a coolant introducing part (coolant injection part) 36 for introducing the coolant into the cylinder 32 is controlled. FIG. 6B shows a configuration of the coolant introducing part 36.

As shown in FIG. 6B, an outer side part (outer space part) 44 which is positioned at the outside in a radial direction of the cylinder 32 and an inner side part (inner space part) 46 positioned at the inside in a radial direction of the cylinder 32 are defined by a frame 38. The outer side part 44 and the inner side part 46 are parted by a partition 40, and the outer side part 44 and the inner side part 46 are connected by a passage 42 formed at an upper part in center axis direction of the partition 40. Such configuration allows the coolant to flow.

At the outer side part 44, a single nozzle 37 is connected which allows the coolant to flow from the nozzle 37 to the outer side part 44. The nozzle 37 may be a plurality of nozzles. Also, at a lower side in the center axis O direction of the inner side part 46, a coolant discharging port 52 is formed and the coolant inside of the inner side part 46 can be discharged (introduced) into the cylinder 32 from the coolant discharging port 52.

An outer circumference face of the frame 38 is a coolant flow inner circumference 38b which guides the flow of the coolant in the inner side part 46. At a lower end 38a of the frame 38, an outer projection 38al is formed which is continuous with the coolant flow inner circumference 38b and is projecting to the outer side in a radial direction. Thus, a ring form space between a tip of the outer projection 38a1 and an inner face 33 of the cylinder 32 becomes the coolant discharging port 52. At an upper face of the coolant flow side of the outer projection 38a1, a coolant flow deflecting face 62 is formed.

As shown in FIG. 6B, due to the outer projection 38a1, a radial direction width D1 of the coolant discharging port 52 is narrower than a radial direction width D2 at a main part of the inner side part 46. As D1 is narrower than D2, the coolant descending towards lower direction of center axis O along the coolant flow inner circumference 38b of the inner side part 46 collides and deflects at the inner face 33 of the cylinder 32 by flowing along the coolant deflecting face 62 of the frame 38. As a result, as shown in FIG. 6A, the coolant is discharged in an inverted cone shape from the coolant discharging port 52 at the inside of the cylinder 32, and forms the coolant flow 50. Note that, in case of D1=D2, the coolant discharged from the coolant discharging port 52 forms a coolant flow along the inner face 33 of the cylinder 32.

Preferably, D1/D2 is ⅔ or less, more preferably ½ or less, ad most preferably 1/10 or more.

Note that, the coolant flow 50 flowing from the coolant discharging port 52 is a straight line of flow in an inverted cone form which flows towards the center axis O from the coolant discharging port 52. However, the coolant flow 50 may be a spiral flow in an inverted cone form.

Also, an injection amount of the molten metal, a gas spraying pressure, a pressure inside the cylinder 32, a coolant discharging pressure, D1/D2, and the like may be determined depending on the desired particle size of the soft magnetic alloy powder. The injection amount of the molten metal may for example be 1 kg/min or more and 20 kg/min or less. The gas spraying pressure may for example be 0.5 MPa or more and 19 MPa or less. The pressure inside the cylinder 32 may for example be 0.5 MPa or more and 19 MPa or less. The coolant discharging pressure may for example be 0.5 MPa or more and 19 MPa or less.

As the injection amount of the molten metal decreases, the particle size decreases, and the amorphous soft magnetic alloy powder tends to be produced easily.

As the gas spraying pressure, the pressure inside the cylinder 32, and the coolant discharging pressure increase, the particle size decreases and the circularity of the particle tends to decrease.

Note that, regarding the particle size, a particle size can be regulated for example by a sieve classification, an airflow classification, and the like. In below, a method of regulating the particle size by a sieve classification is described.

In a sieve classification, the particle size can be regulated for example by changing a powder feed amount per one sieving process, a sieving time, and/or a mesh size. Further, by appropriately controlling the powder feed amount per one sieving process, a sieving time, and/or a mesh size, the soft magnetic alloy powder having a desired particle size can be obtained.

As the powder feed amount per one sieving process increases, the average circularity of the particles tends to decrease easily. As the sieving time decreases, the average circularity of the particles tends to decrease easily. As the mesh size increases, the average circularity of the particles tends to decrease easily.

As other method for regulating the particle size, a method of changing the number of times of passing the powder through mesh may be mentioned. Even in case the mesh sizes are the same, by increasing the number of times of passing the powder through the mesh, deformed particles can be extracted even more. By extracting more deformed particles, the average circularity of the powder can be improved.

The particle size may be regulated by blending a plurality of types of soft magnetic alloy powders.

A purpose of use of the soft magnetic alloy powder according to the present embodiment is not particularly limited. For example, a dust core may be mentioned. When the soft magnetic alloy powder according to the present embodiment is used, even if a pressure while producing the dust core is made relatively low, a suitable permeability μ tends to be obtained easily. This is because the broad particle size distribution is obtained, even when the pressure while producing the dust core is made relatively low, the dust core tends to be densified easily. Specifically, the pressure while producing the dust core can be 98 MPa or more and 1500 MPa or less.

Also, the dust core according to the present embodiment can be suitably used as a dust core for an inductor, particularly for a power inductor. Further, the dust core according to the present embodiment can be suitably used as an inductor in which a dust core and a coil part are integrally formed.

Also, the dust core according to the present embodiment can be suitably used for a magnetic component using the soft magnetic alloy powder, such as a thin film inductor, a magnetic head, and so on. Further, the dust core and the magnetic component using the soft magnetic alloy powder according to the present embodiment can be suitably used for an electronic device.

### EXAMPLES

Hereinafter, the present invention is described based on examples.

### (Experiment 1)

An ingot of each material was prepared and weighed so that a mother alloy having a composition shown in below Table 1 was obtained. Then, it was placed inside a crucible provided in a water atomization equipment. Next, while under an inert atmosphere, the crucible was heated to 1500° C. using a work coil provided at outside of the crucible, then the ingot inside the crucible was melted and mixed to obtain a molten metal (molten).

Next, the molten inside the crucible was sprayed out from a nozzle provided to the crucible, and at the same time, a high-pressured water stream of 100 MPa was collided to the sprayed molten for quenching. Thereby, the soft magnetic alloy powder of each Example and Comparative example shown in Table 1 was produced. Also, ICP analysis was used to confirm that the composition of the mother alloy and the composition of the soft magnetic alloy powder were about the same.

A sieve classification was performed to the obtained soft magnetic alloy powder. Conditions of the sieve classification were a feed amount per one sieving process of 0.5 kg, and a sieving time of 1 min. Further, a mesh size was opening of 38 μm.

The obtained soft magnetic alloy powder was verified whether it was amorphous or crystal. An amorphous ratio X (%) of each ribbon was measured using XRD, and when X (%) was 85% or more, it was considered as amorphous. When X (%) was less than 85%, it was considered as crystal. Results are shown in Table 1.

HcJ and Bs of the obtained soft magnetic alloy powder were measured. HcJ was measured by a Hc meter. Results are shown in Table 1. In Experiment 1, HcJ of 2.4 Oe or less was considered good, and 1.0 Oe or less was considered even better. Bs of 0.70 T or more was considered good, and 1.40 T or more was considered even better.

Shape of the powder particle of the obtained soft magnetic alloy powder was evaluated. Specifically, a volume-based D50 (r), a number-based D50, a number-based σ, and a number-based average circularity of the particles having particle sizes of r or more and 2r or less were evaluated. Results are shown in Table 1.

In Experiment 1, the volume-based D50 (r) was 10 to 11 μm, and the number-based D50 was 4 to 5 μm.

The volume-based D50 (r) was measured using a laser diffraction particle size distribution analyzer (HELOS&RODOS made by Sympatec GmbH).

The number-based D50 and the number-based a were measured by observing the shapes of 20000 powder particles under a magnification of 10× using a Morphologi G3 (made by Malvern Panalytical Ltd). Specifically, the soft magnetic alloy powder of 3 cc volume was dispersed by an air pressure of 1 to 3 bar then a projection image by a laser microscope was taken. The number-based D50 and the number-based a were calculated based on the particle size of each powder particle. Note that, the particle size of each powder particle was a circle equivalent diameter.

In Experiment 1, a of 2.5 μm or more was considered good.

The number-based average circularity of the particles having the particle sizes of r or more and 2r or less was calculated by measuring and taking an average of circularities of the powder particles having the particle sizes of r or more and 2r or less from 20000 powder particles.

Next, a toroidal core was produced using the soft magnetic alloy powder. Specifically, a phenol resin as an insulation binder was mixed in an amount so that it was 3 mass % with respect to the soft magnetic alloy powder. Then, using a general planetary mixer as a mixer, a granulated powder of 500 μm or so was produced. Next, the obtained granulated powder was compacted at a surface pressure of 4 ton/cm² (392 MPa), and a toroidal shaped green compact having outer diameter of 13 mmφ, inner diameter of 8 mmφ, and height of 6 mm was produced. The obtained green compact was cured at 150° C. and a toroidal core was produced.

Then, UEW wire was wound to the toroidal core, and p (permeability) was measured at 100 kHz using 4284A PRECISION LCR METER (Hewlett-Packard Company). In Experiment 1, μ of 25 or more was considered good.

TABLE 1

| | | Fe_{(1-(a+b+c+d+e+f))}MₐB_{b}P_{c}Si_{d}CₑS_{f} (α = β = 0) | | | | | | | | | Soft magnetic alloy powder | | | | | | | |
|---|---|---|---|---|---|---|---|---|---|---|---|---|---|---|---|---|---|---|
| | | | | | | | | | M + | | | | | | Number-based | | | |
| | | | | | | | | | B + | | | | | | | | Average | |
| | | | | | | | | | P + | | | | | Vol- | | | circu- | To- |
| | Exam- | | | | | | | | Si + | | | | | ume- | | | larity | roidal |
| | ple/ | | | | | | | | C | | | | | based | | | of r or | core |
| Sam- | Com- | | M | | | | | | a + b + | | | | | D50 | | | more | Perme- |
| ple | parative | | (Nb) | B | P | Si | C | S | c + | C + S | | HcJ/ | Bs/ | (r)/ | D50/ | σ/ | and 2r | ability |
| No. | example | Fe | a | b | c | d | e | f | d + e | e + f | XRD | Oe | T | μm | μm | μm | or less | μ |
| 1 | Com- | 0.770 | 0.000 | 0.100 | 0.030 | 0.100 | 0.000 | 0.0000 | 0.230 | 0.000 | Amor- | 2.5 | 1.62 | 10.3 | 4.5 | 2.4 | 0.83 | 24 |
| | parative | | | | | | | | | | phous | | | | | | | |
| | example | | | | | | | | | | | | | | | | | |
| 2 | Com- | 0.760 | 0.000 | 0.100 | 0.030 | 0.100 | 0.010 | 0.0000 | 0.240 | 0.010 | Amor- | 1.8 | 1. [symbol] 1 | 10.4 | 4.6 | 2.3 | 0.82 | 23 |
| | parative | | | | | | | | | | phous | | | | | | | |
| | example | | | | | | | | | | | | | | | | | |
| 3 | Com- | 0.740 | 0.000 | 0.100 | 0.030 | 0.100 | 0.030 | 0.0000 | 0.260 | 0.030 | Amor- | 1.7 | 1.60 | 10.2 | 4.5 | 2.2 | 0.84 | 23 |
| | parative | | | | | | | | | | phous | | | | | | | |
| | example | | | | | | | | | | | | | | | | | |
| 4 | Com- | 0.720 | 0.000 | 0.100 | 0.030 | 0.100 | 0.050 | 0.0000 | 0.280 | 0.050 | Amor- | 1.6 | 1.59 | 10.4 | 4.7 | 2.1 | 0.83 | 22 |
| | parative | | | | | | | | | | phous | | | | | | | |
| | example | | | | | | | | | | | | | | | | | |
| 5 | Com- | 0.769 | 0.000 | 0.100 | 0.030 | 0.100 | 0.000 | 0.0010 | 0.230 | 0.001 | Amor- | 2.7 | 1. [symbol] 2 | 10.5 | 4.4 | 2. [symbol] | 0. [symbol] 2 | 24 |
| | parative | | | | | | | | | | phous | | | | | | | |
| | example | | | | | | | | | | | | | | | | | |
| 6 | Com- | 0.765 | 0.000 | 0.100 | 0.030 | 0.100 | 0.000 | 0.0050 | 0.230 | 0.005 | Amor- | 2.8 | 1.61 | 10.4 | 4.3 | 2.7 | 0.83 | 24 |
| | parative | | | | | | | | | | phous | | | | | | | |
| | example | | | | | | | | | | | | | | | | | |
| 7 | Com- | 0.760 | 0.000 | 0.100 | 0.030 | 0.100 | 0.000 | 0.0100 | 0.230 | 0.010 | Amor- | 3.0 | 1. [symbol] 1 | 10.3 | 4.2 | 2.9 | 0.82 | 23 |
| | parative | | | | | | | | | | phous | | | | | | | |
| | example | | | | | | | | | | | | | | | | | |
| 2 | Com- | 0.760 | 0.000 | 0.100 | 0.030 | 0.100 | 0.010 | 0.0000 | 0.240 | 0.010 | Amor- | 1.8 | 1.61 | 10.4 | 4.6 | 2.3 | 0.82 | 23 |
| | parative | | | | | | | | | | phous | | | | | | | |
| | example | | | | | | | | | | | | | | | | | |
| 8 | Ex- | 0.760 | 0.000 | 0.100 | 0.030 | 0.100 | 0.010 | 0.0001 | 0.240 | 0.010 | Amor- | 1.8 | 1. [symbol] 1 | 10.6 | 4.3 | 2.8 | 0.84 | 30 |
| | ample | | | | | | | | | | phous | | | | | | | |
| 9 | Ex- | 0.759 | 0.000 | 0.100 | 0.030 | 0.100 | 0.010 | 0.0010 | 0.240 | 0.011 | Amor- | 1.7 | 1.52 | 10.3 | 4.5 | 2.8 | 0.84 | 29 |
| | ample | | | | | | | | | | phous | | | | | | | |
| 10 | Ex- | 0.755 | 0.000 | 0.100 | 0.030 | 0.100 | 0.010 | 0.0050 | 0.240 | 0.015 | Amor- | 1.6 | 1.48 | 10.5 | 4.4 | 2.9 | 0.82 | 30 |
| | ample | | | | | | | | | | phous | | | | | | | |
| 11 | Ex- | 0.750 | 0.000 | 0.100 | 0.030 | 0.100 | 0.010 | 0.0100 | 0.240 | 0.020 | Amor- | 1.4 | 1.45 | 10.2 | 4.6 | 3.1 | 0. [symbol] 3 | 31 |
| | ample | | | | | | | | | | phous | | | | | | | |
| 12 | Ex- | 0.740 | 0.000 | 0.100 | 0.030 | 0.100 | 0.010 | 0.0200 | 0.240 | 0.030 | Amor- | 1.4 | 1.48 | 10.3 | 4.6 | 3.1 | 0.85 | 32 |
| | ample | | | | | | | | | | phous | | | | | | | |
| 13 | Com- | 0.710 | 0.000 | 0.100 | 0.030 | 0.100 | 0.010 | 0.0500 | 0.240 | 0.060 | Crystal | ≥30 | 1.32 | 10. [symbol] | 4.6 | 3.2 | 0.84 | 24 |
| | parative | | | | | | | | | | | | | | | | | |
| | example | | | | | | | | | | | | | | | | | |
| 14 | Com- | 0.749 | 0.000 | 0.100 | 0.150 | 0.000 | 0.001 | 0.0000 | 0.251 | 0.001 | Amor- | 2.4 | 1.43 | 10.4 | 4.3 | 2.2 | 0.84 | 22 |
| | parative | | | | | | | | | | phous | | | | | | | |
| | example | | | | | | | | | | | | | | | | | |
| 15 | Com- | 0.750 | 0.000 | 0.100 | 0.140 | 0.000 | 0.010 | 0.0000 | 0.250 | 0.010 | Amor- | 2.3 | 1.43 | 10.5 | 4.4 | 2.3 | 0.85 | 23 |
| | parative | | | | | | | | | | phous | | | | | | | |
| | example | | | | | | | | | | | | | | | | | |
| 16 | Com- | 0.750 | 0.000 | 0.100 | 0.050 | 0.000 | 0.100 | 0.0000 | 0.250 | 0.100 | Amor- | 2.1 | 1.43 | 10.6 | 4.3 | 2.2 | 0.85 | 24 |
| | parative | | | | | | | | | | phous | | | | | | | |
| | example | | | | | | | | | | | | | | | | | |
| 17 | Com- | 0.750 | 0.000 | 0.100 | 0.000 | 0.000 | 0.150 | 0.0000 | 0.250 | 0.150 | Amor- | 2.5 | 1.43 | 10.6 | 4.5 | 2.1 | 0.86 | 23 |
| | parative | | | | | | | | | | phous | | | | | | | |
| | example | | | | | | | | | | | | | | | | | |
| 18 | Ex- | 0.748 | 0.000 | 0.100 | 0.150 | 0.000 | 0.001 | 0.0010 | 0.251 | 0.002 | Amor- | 2.3 | 1.43 | 10.6 | 4.5 | 2.8 | 0.84 | 28 |
| | ample | | | | | | | | | | phous | | | | | | | |
| 19 | Ex- | 0.749 | 0.000 | 0.100 | 0.140 | 0.000 | 0.010 | 0.0010 | 0.250 | 0.011 | Amor- | 2.2 | 1.43 | 10.7 | 4.3 | 2.7 | 0.86 | 31 |
| | ample | | | | | | | | | | phous | | | | | | | |
| 20 | Ex- | 0.749 | 0.000 | 0.100 | 0.050 | 0.000 | 0.100 | 0.0010 | 0.250 | 0.101 | Amor- | 2.1 | 1.43 | 10.3 | 4.3 | 2.6 | 0.84 | 33 |
| | ample | | | | | | | | | | phous | | | | | | | |
| 21 | Ex- | 0.749 | 0.000 | 0.100 | 0.000 | 0.000 | 0.150 | 0.0010 | 0.250 | 0.151 | Amor- | 2.4 | 1.43 | 10.4 | 4.5 | 2. [symbol] | 0.86 | 32 |
| | ample | | | | | | | | | | phous | | | | | | | |
| 22 | Com- | 0.720 | 0.000 | 0.070 | 0.000 | 0.200 | 0.010 | 0.0000 | 0.280 | 0.010 | Amor- | 2.4 | 1.35 | 10.5 | 4.5 | 2.3 | 0.85 | 23 |
| | parative | | | | | | | | | | phous | | | | | | | |
| | example | | | | | | | | | | | | | | | | | |
| 23 | Com- | 0.700 | 0.000 | 0.150 | 0.000 | 0.100 | 0.050 | 0.0000 | 0.300 | 0.050 | Amor- | 2.2 | 1.33 | 10.4 | 4.1 | 2.3 | 0.87 | 21 |
| | parative | | | | | | | | | | phous | | | | | | | |
| | example | | | | | | | | | | | | | | | | | |
| 24 | Com- | 0.700 | 0.000 | 0.200 | 0.000 | 0.000 | 0.100 | 0.0000 | 0.300 | 0.100 | Amor- | 2.1 | 1.33 | 10.6 | 4.6 | 2.0 | 0.85 | 22 |
| | parative | | | | | | | | | | phous | | | | | | | |
| | example | | | | | | | | | | | | | | | | | |
| 25 | Ex- | 0.719 | 0.000 | 0.070 | 0.000 | 0.200 | 0.010 | 0.0010 | 0.280 | 0.011 | Amor- | 2.2 | 1.33 | 10.5 | 4.5 | 2.6 | 0.86 | 32 |
| | ample | | | | | | | | | | phous | | | | | | | |
| 26 | Ex- | 0.699 | 0.000 | 0.150 | 0.000 | 0.100 | 0.050 | 0.0010 | 0.300 | 0.051 | Amor- | 2.1 | 1.33 | 10.4 | 4.5 | 2.7 | 0.86 | 31 |
| | ample | | | | | | | | | | phous | | | | | | | |
| 27 | Ex- | 0.699 | 0.000 | 0.200 | 0.000 | 0.000 | 0.100 | 0.0010 | 0.300 | 0.101 | Amor- | 2.2 | 1.33 | 10.3 | 4.5 | 2.8 | 0.85 | 31 |
| | ample | | | | | | | | | | phous | | | | | | | |
| 28 | Ex- | 0.749 | 0.030 | 0.090 | 0.030 | 0.090 | 0.010 | 0.0010 | 0.250 | 0.011 | Amor- | 0.8 | 1.25 | 10. [symbol] | 4.4 | 2.6 | 0.85 | 33 |
| | ample | | | | | | | | | | phous | | | | | | | |
| 29 | Ex- | 0.729 | 0.070 | 0.090 | 0.010 | 0.090 | 0.010 | 0.0010 | 0.270 | 0.011 | Amor- | 0.6 | 0.89 | 10.5 | 4.4 | 2. [symbol] | 0.85 | 31 |
| | ample | | | | | | | | | | phous | | | | | | | |
| 30 | Ex- | 0.719 | 0.150 | 0.090 | 0.030 | 0.000 | 0.010 | 0.0010 | 0.280 | 0.011 | Amor- | 1.2 | 0.70 | 10.4 | 4.4 | 2. [symbol] | 0.8 [symbol] | 32 |
| | ample | | | | | | | | | | phous | | | | | | | |
| 28a | Ex- | 0.779 | 0.000 | 0.090 | 0.030 | 0.090 | 0.010 | 0.0010 | 0.220 | 0.011 | Amor- | 0.8 | 1.55 | 10.6 | 4.4 | 2. [symbol] | 0.85 | 33 |
| | ample | | | | | | | | | | phous | | | | | | | |
| 28b | Ex- | 0.769 | 0.010 | 0.090 | 0.030 | 0.090 | 0.010 | 0.0010 | 0.230 | 0.011 | Amor- | 0.8 | 1.55 | 10.6 | 4.4 | 2.7 | 0.85 | 33 |
| | ample | | | | | | | | | | phous | | | | | | | |
| 28c | Ex- | 0.760 | 0.019 | 0.090 | 0.030 | 0.090 | 0.010 | 0.0010 | 0.239 | 0.011 | Amor- | 0.8 | 1.41 | 10.6 | 4.4 | 2.6 | 0.85 | 33 |
| | ample | | | | | | | | | | phous | | | | | | | |
| 29a | Ex- | 0.759 | 0.020 | 0.090 | 0.030 | 0.090 | 0.010 | 0.0010 | 0.240 | 0.011 | Amor- | 0.8 | 1.39 | 10.6 | 4.4 | 2. [symbol] | 0.85 | 33 |
| | ample | | | | | | | | | | phous | | | | | | | |

[symbol]

indicates data missing or illegible when filed

According to Table 1, all of Examples and Comparative examples had 0.70 or more of the number-based average circularity of the particles having the particle sizes of r or more and 2r or less.

According to Table 1, the soft magnetic alloy powder of Sample No. 1 which was a comparative example not including C and S had a high and a low σ. Also, the toroidal core had a low μ.

The soft magnetic alloy powders of Sample No. 5 to 7 having compositions of which only S was added to the composition of the soft magnetic alloy powder of Sample No. 1 had even higher HcJ compared to the soft magnetic alloy powder of Sample No. 1 due to addition of S. Further, μ of Sample No. 5 to 7 were low similar as to the toroidal core of Sample No. 1.

The soft magnetic alloy powders of Sample No. 2 to 4 having compositions of which C was added to the composition of the soft magnetic alloy powder of Sample No. 1 had decreased HcJ and also decreased σ compared to the soft magnetic alloy powder of Sample No. 1. Further, μ of Sample No. 2 to 4 decreased compared to the toroidal core of Sample No. 1.

The soft magnetic alloy powders as examples shown by Sample No. 8 to 12 having compositions of which S was added in a predetermined range of amount to the soft magnetic alloy powder of Sample No. 2 exhibited good HcJ and a. Further, a toroidal core using the soft magnetic alloy powder of Sample No. 8 to 12 exhibited good p. Note that, in Sample No. 13 in which S amount (f) was too much, the soft magnetic alloy powder included crystals having crystal sizes of 100 nm or more, and the amorphous ratio X (%) was less than 85%. Also, HcJ was significantly increased, and μ of the toroidal core was low.

Sample No. 14 to 17 show the soft magnetic alloy powders of comparative examples in which P amount (c) and C amount (e) were changed while M, Si, and S were not included. Sample No. 14 to 17 exhibited a low σ; and μ of the toroidal core was low. Also, Sample No. 17 which had a large amount of C exhibited increased HcJ.

Sample No. 18 to 21 show the soft magnetic alloy powders of examples in which S amount (f) were varied within a range of 0 to 0.0010 with respect to Sample No. 14 to 17. Sample No. 18 to 21 exhibited good HcJ and σ. Further, μ of the toroidal core using the soft magnetic alloy powder was good.

Sample No. 22 to 24 show the soft magnetic alloy powders of comparative examples having compositions in which B amount (b), Si amount (d), and C amount (e) were varied while M, P, and S were not included. Sample No. 22 to 24 exhibited a low σ; and μ of the toroidal core was low.

Sample No. 25 to 27 show the soft magnetic alloy powders of examples having compositions in which S amount (f) was varied within a range of 0 to 0.0010 with respect to Sample No. 22 to 24. Sample No. 25 to 27 exhibited good HcJ and σ. Further, μ of the toroidal core using the soft magnetic alloy powder was good.

Examples of Sample No. 25 to 27 exhibited lower Bs compared to examples of Sample No. 8 to 12 and 18 to 21. This is due to a low Fe amount.

Sample No. 28 to 30 and 28a to 28d show the soft magnetic alloy powders of examples which are different from the above-mentioned examples; and Sample No. 28 to 30 and 28a to 28d included Nb as M. As similar to the examples which did not include M, Sample No. 28 to 30 and 28a to 28d exhibited good HcJ and σ. Also, the examples satisfying 0≤a<0.020 exhibited better Bs compared to the examples satisfying a≥0.020. Further, μ of the toroidal core using the soft magnetic alloy powder was good.

Note that, in each examples of Experiment 1, the number-based average circularity of the particles having the particle sizes of 25 μm or more and 30 μm or less was calculated, and also the number-based average circularity of the particles having the particle sizes of 5 μm or more and 10 μm or less was calculated. As a result, regarding all of the examples, the number-based average circularity of the particles having the particle sizes of 25 μm or more and 30 μm or less was 0.70 or more; and the number-based average circularity of the particles having the particle sizes of 5 μm or more and 10 μm or less was 0.90 or more.

### (Experiment 2)

Experiment 2 was performed as similar to Experiment 1 except that an atomization method was changed to a gas atomization method from a water atomization method, and sieve classification conditions were changed. An atomization equipment shown in FIG. 6A and FIG. 6B was used.

Hereinafter, an ingot of each material was prepared and weighed so that a mother alloy having a composition shown in below Table 2 was obtained.

Next, the mother alloy was placed in a heat resistant container 22 provided in an atomization equipment 10. Then, after vacuuming inside of the cylinder 32, the heat resistant container 22 was heated by high frequency induction using a heating coil 24 provided outside of the heat resistant container 22. Then, the raw material metal in the heat resistant container 22 was melted and mixed, thereby a molten metal (molten) of 1500° C. was obtained.

The obtained molten was sprayed at a temperature of 1500° C. into the cylinder 32 of a cooling part 30, then argon gas was sprayed at a spraying pressure of 7 MPa to form many droplets. The droplets collided to with coolant flow of inverted cone shape which was formed by a cooling water supplied at a pump pressure (coolant discharging pressure) of 10 MPa, thereby the droplets changed into a fine powder, and the fine powder was collected. Note that, the pressure inside the cylinder 32 was 0.5 MPa.

Note that, regarding the atomization equipment 10 shown in FIG. 6A and FIG. 6B, inner diameter of an inner surface of the cylinder 32 was 300 mm, D1/D2 was ½, and an angle θ1 was 20 degrees.

A sieve classification was performed to the obtained soft magnetic alloy powder. Conditions of the sieve classification were, a feed amount per one sieving process of 0.05 kg, and a sieving time of 5 minutes. Further, an opening of a mesh size was 63 μm.

In Experiment 2, unlike Experiment 1, the volume-based D50 (r) was 22 to 27 μm, and the number-based D50 was 8 to 9 μm. Also, In Experiment 2, for all of the examples and the comparative examples, the number-based average circularity of the particles having the particle sizes of r or more and 2r or less was 0.90 or more. Also, in Experiment 2, a of 7.0 μm or more was considered good. Also, a permeability μ of a toroidal core of 33 or more was considered good. Results are shown in Table 2.

TABLE 2

| | | Fe_{(1-(a+b+c+d+e+f))}MₐB_{b}P_{c}Si_{d}CₑS_{f} (α = β = 0) | | | | | | | | |
|---|---|---|---|---|---|---|---|---|---|---|
| | Example/ | | | | | | | | M + B + P + | |
| Sample | Comparative | | M(Nb) | B | P | Si | C | S | Si + C | C + S |
| No. | example | Fe | a | b | c | d | e | f | a + b + c + d + e | e + f |
| 31 | Comparative | 0.770 | 0.000 | 0.100 | 0.030 | 0.100 | 0.000 | 0.0000 | 0.230 | 0.000 |
| | example | | | | | | | | | |
| 32 | Comparative | 0.7 [symbol] 0 | 0.000 | 0.100 | 0.030 | 0.100 | 0.010 | 0.0000 | 0.240 | 0.010 |
| | example | | | | | | | | | |
| 33 | Comparative | 0.740 | 0.000 | 0.100 | 0.030 | 0.100 | 0.030 | 0.0000 | 0.250 | 0.030 |
| | example | | | | | | | | | |
| 34 | Comparative | 0.720 | 0.000 | 0.100 | 0.030 | 0.100 | 0.050 | 0.0000 | 0.2 [symbol] 0 | 0.050 |
| | example | | | | | | | | | |
| 35 | Comparative | 0.7 [symbol] 9 | 0.000 | 0.100 | 0.030 | 0.100 | 0.000 | 0.0010 | 0.230 | 0.001 |
| | example | | | | | | | | | |
| 36 | Comparative | 0.765 | 0.000 | 0.100 | 0.030 | 0.100 | 0.000 | 0.0050 | 0.230 | 0.005 |
| | example | | | | | | | | | |
| 37 | Comparative | 0.7 [symbol] 0 | 0.000 | 0.100 | 0.030 | 0.100 | 0.000 | 0.0100 | 0.230 | 0.010 |
| | example | | | | | | | | | |
| 32 | Comparative | 0.760 | 0.000 | 0.100 | 0.030 | 0.100 | 0.010 | 0.0000 | 0.240 | 0.010 |
| | example | | | | | | | | | |
| 38 | Example | 0.7 [symbol] 0 | 0.000 | 0.100 | 0.030 | 0.100 | 0.010 | 0.0001 | 0.240 | 0.010 |
| 39 | Example | 0.759 | 0.000 | 0.100 | 0.030 | 0.100 | 0.010 | 0.0010 | 0.240 | 0.011 |
| 40 | Example | 0.755 | 0.000 | 0.100 | 0.030 | 0.100 | 0.010 | 0.0050 | 0.240 | 0.015 |
| 41 | Example | 0.750 | 0.000 | 0.100 | 0.030 | 0.100 | 0.010 | 0.0100 | 0.240 | 0.020 |
| 42 | Example | 0.740 | 0.000 | 0.100 | 0.030 | 0.100 | 0.010 | 0.0200 | 0.240 | 0.030 |
| 43 | Comparative | 0.710 | 0.000 | 0.100 | 0.030 | 0.100 | 0.010 | 0.500 | 0.240 | 0.0 [symbol] 0 |
| | example | | | | | | | | | |
| 44 | Comparative | 0.749 | 0.000 | 0.100 | 0.150 | 0.000 | 0.001 | 0.0000 | 0.251 | 0.001 |
| | example | | | | | | | | | |
| 45 | Comparative | 0.750 | 0.000 | 0.100 | 0.140 | 0.000 | 0.010 | 0.0000 | 0.250 | 0.010 |
| | example | | | | | | | | | |
| 46 | Comparative | 0.750 | 0.000 | 0.100 | 0.050 | 0.000 | 0.100 | 0.0000 | 0.250 | 0.100 |
| | example | | | | | | | | | |
| 47 | Comparative | 0.750 | 0.000 | 0.100 | 0.000 | 0.000 | 0.150 | 0.0000 | 0.250 | 0.150 |
| | example | | | | | | | | | |
| 48 | Example | 0.748 | 0.000 | 0.100 | 0.150 | 0.000 | 0.001 | 0.0010 | 0.251 | 0.002 |
| 49 | Example | 0.749 | 0.000 | 0.100 | 0.140 | 0.000 | 0.010 | 0.0010 | 0.250 | 0.011 |
| 50 | Example | 0.749 | 0.000 | 0.100 | 0.050 | 0.000 | 0.100 | 0.0010 | 0.250 | 0.101 |
| 51 | Example | 0.749 | 0.000 | 0.100 | 0.000 | 0.000 | 0.150 | 0.0010 | 0.250 | 0.151 |
| 52 | Comparative | 0.720 | 0.000 | 0.070 | 0.000 | 0.200 | 0.010 | 0.0000 | 0.2 [symbol] 0 | 0.010 |
| | example | | | | | | | | | |
| 53 | Comparative | 0.700 | 0.000 | 0.150 | 0.000 | 0.100 | 0.050 | 0.0000 | 0.300 | 0.050 |
| | example | | | | | | | | | |
| 54 | Comparative | 0.700 | 0.000 | 0.200 | 0.000 | 0.000 | 0.100 | 0.0000 | 0.300 | 0.100 |
| | example | | | | | | | | | |
| 55 | Example | 0.719 | 0.000 | 0.070 | 0.000 | 0.200 | 0.010 | 0.0010 | 0.280 | 0.011 |
| 56 | Example | 0.699 | 0.000 | 0.150 | 0.000 | 0.100 | 0.050 | 0.0010 | 0.300 | 0.051 |
| 57 | Example | 0.699 | 0.000 | 0.200 | 0.000 | 0.000 | 0.100 | 0.0010 | 0. [symbol] 00 | 0.101 |
| 58 | Example | 0.749 | 0.030 | 0.090 | 0.030 | 0.090 | 0.010 | 0.0010 | 0.250 | 0.011 |
| 59 | Example | 0.729 | 0.070 | 0.090 | 0.010 | 0.090 | 0.010 | 0.0010 | 0.270 | 0.011 |
| 60 | Example | 0.719 | 0.150 | 0.090 | 0.030 | 0.000 | 0.010 | 0.0010 | 0.280 | 0.011 |
| 58a | Example | 0.779 | 0.000 | 0.090 | 0.030 | 0.090 | 0.010 | 0.0010 | 0.220 | 0.011 |
| 58b | Example | 0.769 | 0.010 | 0.090 | 0.030 | 0.090 | 0.010 | 0.0010 | 0.230 | 0.011 |
| 58c | Example | 0.7 [symbol] 0 | 0.019 | 0.090 | 0.030 | 0.090 | 0.010 | 0.0010 | 0.2 [symbol] 9 | 0.011 |
| 58d | Example | 0.759 | 0.020 | 0.090 | 0.030 | 0.090 | 0.010 | 0.0010 | 0.240 | 0.011 |
| 60a | Example | 0.819 | 0.070 | 0.080 | 0.020 | 0.000 | 0.010 | 0.0010 | 0.180 | 0.011 |
| 60b | Example | 0.849 | 0.040 | 0.080 | 0.020 | 0.000 | 0.010 | 0.0010 | 0.150 | 0.011 |

| | Soft magnetic alloy powder | | | | | | | |
|---|---|---|---|---|---|---|---|---|
| | | | | | Number-based | | | |
| | | | | Volume | | | | Toroidal |
| | | | | based | | | Average | core |
| Sample | | | | D50 | | | circularity of r or | Permeability |
| No. | XRD | HcJ/Oe | Bs/T | (r)/μm | D50/μm | σ/μm | more and 2r or less | μ |
| 31 | Amorphous | 1.8 | 1.82 | 23.0 | 8.9 | 5.4 | 0.92 | 28 |
| 32 | Amorphous | 1.6 | 1.61 | 23.0 | 8. [symbol] | 5.4 | 0.91 | 27 |
| 33 | Amorphous | 1.7 | 1.60 | 22.5 | 8.7 | 5.6 | 0.91 | 28 |
| 34 | Amorphous | 1.5 | 1.59 | 22.5 | 2.6 | 5.6 | 0.92 | 29 |
| 35 | Amorphous | 2.9 | 1.62 | 23.4 | 8.8 | 7.2 | 0.92 | 31 |
| 36 | Amorphous | 3.1 | 1.51 | 23.2 | 8.6 | 7.3 | 0.93 | 32 |
| 37 | Amorphous | 3.3 | 1.61 | 22.3 | 8.9 | 7.5 | 0.91 | 32 |
| 32 | Amorphous | 1.6 | 1.81 | 23.0 | 9.8 | 5.4 | 0.91 | 27 |
| 38 | Amorphous | 1.6 | 1. [symbol] 1 | 23.1 | 8.6 | 7.4 | 0.92 | 36 |
| 39 | Amorphous | 1.5 | 1.52 | 22.5 | 8.6 | 7.5 | 0.93 | 38 |
| 40 | Amorphous | 1.5 | 1.48 | 22.5 | 8.5 | 7.3 | 0.92 | 3 [symbol] |
| 41 | Amorphous | 1.3 | 1.45 | 22.4 | 8.6 | 7.4 | 0.93 | 38 |
| 42 | Amorphous | 1.3 | 1.48 | 22.5 | 8.6 | 7.2 | 0.92 | 37 |
| 43 | Crystal | ≥30 | 1.32 | 22.5 | 8.4 | 7.1 | 0.91 | 27 |
| 44 | Amorphous | 2.6 | 1.43 | 23.1 | 8.5 | 5.3 | 0.93 | 28 |
| 45 | Amorphous | 2.3 | 1.49 | 22.2 | 8.6 | 5.4 | 0.92 | 27 |
| 46 | Amorphous | 2. [symbol] | 1.43 | 24.2 | 8.6 | 5.4 | 0.91 | 2 [symbol] |
| 47 | Amorphous | 2.5 | 1.43 | 23.2 | [symbol] .6 | 5.6 | 0.92 | 27 |
| 48 | Amorphous | 2.3 | 1.43 | 23.6 | 8.7 | 7.3 | 0.93 | 36 |
| 49 | Amorphous | 2.1 | 1.43 | 2 [symbol] .6 | [symbol] .4 | 7.2 | 0.94 | 35 |
| 50 | Amorphous | 2.3 | 1.43 | 23.8 | 8.5 | 7.3 | 0.92 | 35 |
| 51 | Amorphous | 2.4 | 1.43 | 23.6 | 8.6 | 7.4 | 0.93 | 27 |
| 52 | Amorphous | 3.3 | 1.35 | 23.5 | 9.5 | 5.3 | 0.93 | 27 |
| 53 | Amorphous | 2.1 | 1.33 | 23.1 | 8.7 | 5.6 | 0.93 | 2 |
| 54 | Amorphous | 2.4 | 1.33 | 23.8 | 8.5 | 5.4 | 0.92 | 2 [symbol] |
| 55 | Amorphous | 1.2 | 1.33 | 22.4 | 8.6 | 7.3 | 0.92 | 36 |
| 56 | Amorphous | 2.0 | 1.33 | 22.1 | 8.7 | 7.4 | 0.91 | 35 |
| 57 | Amorphous | 2.1 | 1.33 | 22.8 | 8.7 | 7.3 | 0.92 | 36 |
| 58 | Amorphous | 0.2 | 1.25 | 24.0 | 8.5 | 7.4 | 0.93 | 35 |
| 59 | Amorphous | 0.9 | 0.89 | 24.3 | 8.5 | 7.3 | 0.93 | 35 |
| 60 | Amorphous | 1.2 | 0.70 | 23.8 | 8.9 | 7.4 | 0.92 | 35 |
| 58a | Amorphous | 1.2 | 1.65 | 24.0 | 8.5 | 7.4 | 0.93 | 35 |
| 58b | Amorphous | 0.8 | 1.55 | 23.8 | 8.5 | 7.4 | 0.93 | 35 |
| 58c | Amorphous | 0.8 | 1.41 | 24.0 | 8.4 | 7.4 | 0.93 | 34 |
| 58d | Amorphous | 0.2 | 1.39 | 23.9 | 8.5 | 7.2 | 0.93 | 35 |
| 60a | Amorphous | 0.9 | 0.87 | 24.9 | 8.5 | 7.3 | 0.92 | 34 |
| 60b | Amorphous | 2.1 | 1.10 | 25.5 | 8.9 | 7.4 | 0.91 | 33 |

[symbol]

indicates data missing or illegible when filed

According to Table 2, in all of the examples and the comparative examples, the number-based average circularity of the particles having the particle sizes of r or more and 2r or less was 0.90 or more.

According to Table 2, the soft magnetic alloy powder of Sample No. 31 as a comparative example which did not include C and S had a high HcJ and a low σ. Further, μ of the toroidal core was low.

The soft magnetic alloy powders of Sample No. 35 to 37 had compositions of which only S was added to the composition of the soft magnetic alloy powder of Sample No. 31, and due to the addition of S, Sample No. 35 to 37 had a higher HcJ compared to the soft magnetic alloy powder of Sample No. 31. Further, as similar to Sample No. 31, Sample No. 35 to 37 had a low μ of the toroidal core.

The soft magnetic alloy powders of Sample No. 32 to 34 had compositions of which only C was added to the composition of the soft magnetic alloy powder of Sample No. 31, and Sample No. 32 to 34 exhibited decreased HcJ and also decreased σ compared to the soft magnetic alloy powder of Sample No. 31. Further, Sample No. 32 to 34 exhibited decreased p of the toroidal core compared to Sample No. 31.

The soft magnetic alloy powders of Sample No. 38 to 42 as examples had compositions of which S in a predetermined range was added to the soft magnetic alloy powder, and Sample No. 38 to 42 exhibited good HcJ and σ. Further, μ of the toroidal core using the soft magnetic alloy powder was good. Note that, in Sample No. 43 having excessive S amount (f), the soft magnetic alloy powder was made of crystals having crystal sizes of 100 nm or more, and HcJ was significantly increased. Also, μ of the toroidal core was low.

Sample No. 44 to 47 were the soft magnetic alloy powders as comparative examples in which P amount (c) and C amount (e) were varied while M, Si, and S were not included. Sample No. 44 to 47 exhibited a low σ, and μ of the toroidal core was low. Also, Sample No. 47 which had a large amount of C exhibited increased HcJ.

The soft magnetic alloy powders of Sample No. 48 to 51 as examples had compositions of which S amount (f) was varied within a range of 0 to 0.0010 with respect to Sample No. 44 to 47. Sample No. 48 to 51 exhibited good HcJ and σ. Further, μ of the toroidal core using the soft magnetic alloy powder was good.

The soft magnetic alloy powders of Sample No. 52 to 54 as comparative examples had compositions of which B amount (b), Si amount (d), and C amount (e) were varied while M, P, and S were not included. Sample No. 52 to 54 exhibited a low σ, and μ of the toroidal core was low.

The soft magnetic alloy powders of Sample No. 55 to 57 as examples had compositions of which S amount (f) was varied within a range of 0 to 0.0010 with respect to Sample No. 52 to 54, and Sample No. 55 to 57 exhibited good HcJ and σ. Further, μ of the toroidal core using the soft magnetic alloy powder was good.

Examples of Sample No. 55 to 57 had smaller Bs compared to examples of Sample No. 38 to 42 and 48 to 51. This is due to a small amount of Fe.

The soft magnetic alloy powders of Sample No. 58 to 60, and 58a to 58d as examples included Nb as M unlike the above-mentioned examples. As similar to examples which included M, Sample No. 58 to 60, and 58a to 58d exhibited good HcJ and σ. Also, examples which satisfied 0≤a<0.020 had better Bs compared to Bs of examples which satisfied a≥0.020. Also, μ of the toroidal core using the soft magnetic alloy powder was good.

The soft magnetic alloy powders of Sample No. 60a to 60d, and 58a to 58d as examples had compositions having higher Fe amount than Sample No. 31 to 60. Even when Fe amount was increased, good HcJ and σ were obtained. Further, μ of the toroidal core using the soft magnetic alloy powder was good.

Also, the soft magnetic alloy powders of Sample No. 61 to 70 were produced as same as Sample No. 58 except for varying types of M. Also, the soft magnetic alloy powders of Sample No. 61b to 70b were produced as same as Sample No. 58b except for varying types of M. Results are shown in Table 3.

TABLE 3

| | | | Soft magnetic alloy powder | | | | | | | |
|---|---|---|---|---|---|---|---|---|---|---|
| | | | | | | | Number-based | | | |
| | | | | | | Volume- | | | Average | |
| | Example/ | | | | | based | | | circularity of r or | Toroidal core |
| Sample | Comparative | | | HcJ/ | Bs/ | D50 (r)/ | D50/ | σ/ | more and 2r or | Permeability |
| No. | example | M | XRD | Oe | T | μm | μm | μm | less | μ |
| 58 | Example | Nb | Amorphous | 0.8 | 1.25 | 24.0 | 8.5 | 7.4 | 0.93 | 35 |
| 61 | Example | Hf | Amorphous | 0.7 | 1.22 | 25.2 | 8.3 | 7.3 | 0.93 | 35 |
| 62 | Example | Zr | Amorphous | 0.8 | 1.23 | 25.2 | 8.2 | 7.3 | 0.93 | 36 |
| 63 | Example | Ta | Amorphous | 0.8 | 1.24 | 23.5 | 8.1 | 7.4 | 0.94 | 34 |
| 64 | Example | Mo | Amorphous | 0.8 | 1.22 | 23.6 | 8.2 | 7.5 | 0.95 | 34 |
| 65 | Example | W | Amorphous | 0.7 | 1.23 | 23.4 | 8.3 | 7.3 | 0.94 | 35 |
| 66 | Example | V | Amorphous | 0.7 | 1.23 | 23.1 | 8.3 | 7.4 | 0.95 | 35 |
| 67 | Example | Ti | Amorphous | 0.8 | 1.22 | 23.5 | 8.4 | 7.2 | 0.95 | 35 |
| 68 | Example | Nb0.5Hf0.5 | Amorphous | 0.9 | 1.21 | 23.2 | 8.5 | 7.4 | 0.93 | 34 |
| 69 | Example | Zr0.5Ta0.5 | Amorphous | 0.8 | 1.22 | 23.7 | 8.4 | 7.4 | 0.92 | 35 |
| 70 | Example | Nb0.4Hf0.3Zr0.3 | Amorphous | 0.7 | 1.22 | 23.6 | 8.4 | 7.4 | 0.94 | 35 |
| 58b | Example | Nb | Amorphous | 0.8 | 1.55 | 23.8 | 8.5 | 7.4 | 0.93 | 35 |
| 61b | Example | Hf | Amorphous | 0.8 | 1.53 | 24.6 | 8.3 | 7.3 | 0.93 | 33 |
| 62b | Example | Zr | Amorphous | 0.8 | 1.53 | 25.1 | 8.2 | 7.1 | 0.93 | 34 |
| 63b | Example | Ta | Amorphous | 0.8 | 1.54 | 23.1 | 8.1 | 7.4 | 0.94 | 34 |
| 64b | Example | Mo | Amorphous | 0.8 | 1.55 | 23.2 | 8.2 | 7.7 | 0.93 | 34 |
| 65b | Example | W | Amorphous | 0.8 | 1.54 | 23.6 | 8.2 | 7.3 | 0.94 | 34 |
| 66b | Example | V | AmorPnous | 0.7 | 1.56 | 23.0 | 8.3 | 7.4 | 0.94 | 35 |
| 67b | Example | Ti | AmorPnous | 0.7 | 1.55 | 23.4 | 8.3 | 7.2 | 0.95 | 34 |
| 68b | Example | Nb0.5Hf0.5 | Amorphous | 0.8 | 1.54 | 23.2 | 8.4 | 7.4 | 0.95 | 34 |
| 69b | Example | Zr0.5Ta0.5 | Amorphous | 0.8 | 1.55 | 23.4 | 8.4 | 7.4 | 0.92 | 33 |
| 70b | Example | Nb0.4Hf0.3Zr0.3 | Amorphous | 0.7 | 1.54 | 23.6 | 8.6 | 7.4 | 0.94 | 33 |

According to Table 3, Sample No. 61 to 70 in which the types of M were varied exhibited good experiment results similar to Sample No. 58. Also, Sample No. 61b to 70b exhibited good experiment results similar to Sample No. 58b.

### (Experiment 3)

In Experiment 3, the soft magnetic alloy powder of Sample No. 71 which satisfied a=0.000, b=0.120, c=0.090, d=0.030, e=0.010, f=0.0010, and α=β=0 was produced. Further, Sample No. 72 to 125 show the soft magnetic alloy powders in which types and amounts of X1 and/or X2 were varied from Sample No. 71. Production conditions of the soft magnetic alloy powders according to Experiment 3 were the same as Experiment 2 other than the composition of the soft magnetic powder. Results are shown in Table 4.

TABLE 4

| | | | | | | Soft magnetic alloy powder | | | | | | | |
|---|---|---|---|---|---|---|---|---|---|---|---|---|---|
| | | | | | | | | | Vol- | Number-based | | | |
| | | X1 | | X2 | | | | | ume- | | | Average | Toroidal |
| | Example/ | | α{1 − | | β{1 − | | | | based | | | circularity | core |
| Sam- | Com- | | (a + b + | | (a + b + | | | | D50 | | | of r or | Perme- |
| ple | parative | | c + d + | | c + d + | | HcJ/ | Bs/ | (r)/ | D50/ | σ/ | more and 2r | ability |
| No. | example | Type | e + f)} | Type | e + f)} | XRD | Oe | T | μm | μm | μm | or less | μ |
| 71 | Example | — | 0.000 | — | 0.000 | Amorphous | 0.8 | 1.43 | 24.0 | 8.5 | 7.4 | 0.93 | 33 |
| 72 | Example | Co | 0.010 | — | 0.000 | Amorphous | 0.9 | 1.52 | 24.2 | 8.4 | 7.3 | 0.91 | 33 |
| 73 | Example | Co | 0.100 | — | 0.000 | Amorphous | 0.8 | 1.61 | 24.3 | 8.3 | 7.5 | 0.92 | 34 |
| 74 | Example | Co | 0.400 | — | 0.000 | Amorphous | 0.8 | 1.72 | 24.3 | 8.4 | 7.4 | 0.91 | 34 |
| 75 | Example | Ni | 0.010 | — | 0.000 | Amorphous | 0.9 | 1.44 | 22.4 | 8.2 | 7.3 | 0.92 | 35 |
| 76 | Example | Ni | 0.100 | — | 0.000 | Amorphous | 0.8 | 1.52 | 22.4 | 8.1 | 7.2 | 0.92 | 35 |
| 77 | Example | Ni | 0.400 | — | 0.000 | Amorphous | 0.8 | 1.45 | 22.6 | 8.4 | 7.3 | 0.94 | 34 |
| 78 | Example | — | 0.000 | Al | 0.001 | Amorphous | 0.8 | 1.43 | 22.7 | 8.6 | 7.4 | 0.92 | 34 |
| 79 | Example | — | 0.000 | Al | 0.005 | Amorphous | 0.8 | 1.44 | 22.6 | 8.3 | 7.3 | 0.91 | 35 |
| 80 | Example | — | 0.000 | Al | 0.010 | Amorphous | 0.8 | 1.44 | 22.6 | 8.5 | 7.4 | 0.91 | 35 |
| 81 | Example | — | 0.000 | Al | 0.030 | Amorphous | 0.9 | 1.43 | 22.9 | 8.4 | 7.4 | 0.93 | 34 |
| 82 | Example | — | 0.000 | Zn | 0.001 | Amorphous | 0.9 | 1.44 | 23.2 | 8.2 | 7.5 | 0.92 | 34 |
| 83 | Example | — | 0.000 | Zn | 0.005 | Amorphous | 0.9 | 1.43 | 23.4 | 8.3 | 7.3 | 0.93 | 33 |
| 84 | Example | — | 0.000 | Zn | 0.010 | Amorphous | 0.9 | 1.45 | 23.1 | 8.4 | 7.1 | 0.91 | 34 |
| 85 | Example | — | 0.000 | Zn | 0.030 | Amorphous | 0.8 | 1.43 | 23.5 | 8.3 | 7.3 | 0.91 | 34 |
| 86 | Example | — | 0.000 | Sn | 0.001 | Amorphous | 0.8 | 1.44 | 23.2 | 8.2 | 7.4 | 0.92 | 34 |
| 87 | Example | — | 0.000 | Sn | 0.005 | Amorphous | 0.8 | 1.43 | 23.4 | 8.4 | 7.3 | 0.93 | 33 |
| 88 | Example | — | 0.000 | Sn | 0.010 | Amorphous | 0.9 | 1.44 | 23.6 | 8.3 | 7.5 | 0.92 | 34 |
| 89 | Example | — | 0.000 | Sn | 0.030 | Amorphous | 0.9 | 1.45 | 24.9 | 8.2 | 7.4 | 0.91 | 34 |
| 90 | Example | — | 0.000 | Cu | 0.001 | Amorphous | 0.9 | 1.45 | 23.6 | 8.4 | 7.9 | 0.93 | 34 |
| 91 | Example | — | 0.000 | Cu | 0.005 | Amorphous | 0.9 | 1.43 | 23.6 | 8.6 | 7.5 | 0.93 | 33 |
| 92 | Example | — | 0.000 | Cu | 0.010 | Amorphous | 0.9 | 1.43 | 23.5 | 8.4 | 7.5 | 0.92 | 33 |
| 93 | Example | — | 0.000 | Cu | 0.030 | Amorphous | 0.8 | 1.43 | 23.1 | 8.5 | 7.6 | 0.91 | 34 |
| 94 | Example | — | 0.000 | Cr | 0.001 | Amorphous | 0.9 | 1.41 | 25.1 | 8.4 | 7.4 | 0.91 | 34 |
| 95 | Example | — | 0.000 | Cr | 0.005 | Amorphous | 0.9 | 1.42 | 26.2 | 8.3 | 7.5 | 0.93 | 33 |
| 96 | Example | — | 0.000 | Cr | 0.010 | Amorphous | 0.9 | 1.41 | 23.1 | 8.2 | 7.3 | 0.92 | 34 |
| 97 | Example | — | 0.000 | Cr | 0.030 | Amorphous | 0.9 | 1.41 | 24.3 | 8.4 | 7.4 | 0.92 | 34 |
| 98 | Example | — | 0.000 | Bi | 0.001 | Amorphous | 0.8 | 1.43 | 24.5 | 8.2 | 7.5 | 0.93 | 35 |
| 99 | Example | — | 0.000 | Bi | 0.005 | Amorphous | 0.9 | 1.43 | 24.3 | 8.4 | 7.4 | 0.92 | 34 |
| 100 | Example | — | 0.000 | Bi | 0.010 | Amorphous | 0.9 | 1.43 | 23.1 | 8.4 | 7.5 | 0.92 | 34 |
| 101 | Example | — | 0.000 | Bi | 0.030 | Amorphous | 0.9 | 1.43 | 23.5 | 8.5 | 7.6 | 0.91 | 34 |
| 102 | Example | — | 0.000 | La | 0.001 | Amorphous | 0.9 | 1.44 | 23.2 | 8.7 | 7.4 | 0.91 | 35 |
| 103 | Example | — | 0.000 | La | 0.005 | Amorphous | 1.1 | 1.45 | 23.5 | 8.3 | 7.5 | 0.91 | 34 |
| 104 | Example | — | 0.000 | La | 0.010 | Amorphous | 1.1 | 1.42 | 23.8 | 8.2 | 7.7 | 0.92 | 34 |
| 105 | Example | — | 0.000 | La | 0.030 | Amorphous | 1.2 | 1.42 | 23.8 | 8.6 | 7.3 | 0.93 | 33 |
| 106 | Example | — | 0.000 | Y | 0.001 | Amorphous | 1.1 | 1.42 | 23.7 | 8.3 | 7.5 | 0.92 | 35 |
| 107 | Example | — | 0.000 | Y | 0.005 | Amorphous | 1.1 | 1.43 | 23.5 | 8.5 | 7.5 | 0.91 | 34 |
| 108 | Example | — | 0.000 | Y | 0.010 | Amorphous | 1.1 | 1.43 | 23.5 | 8.6 | 7.3 | 0.93 | 33 |
| 109 | Example | — | 0.000 | Y | 0.030 | Amorphous | 1.2 | 1.42 | 23.5 | 8.2 | 7.4 | 0.92 | 33 |
| 106a | Example | — | 0.000 | Ga | 0.001 | Amorphous | 0.7 | 1.45 | 23.5 | 8.5 | 7.5 | 0.91 | 37 |
| 107a | Example | — | 0.000 | Ga | 0.005 | Amorphous | 0.7 | 1.44 | 23.5 | 8.6 | 7.3 | 0.93 | 37 |
| 108a | Example | — | 0.000 | Ga | 0.010 | Amorphous | 0.7 | 1.46 | 23.3 | 8.8 | 7.4 | 0.92 | 37 |
| 109a | Example | — | 0.000 | Ga | 0.030 | Amorphous | 0.7 | 1.45 | 23.4 | 8.4 | 7.3 | 0.93 | 38 |
| 110 | Example | Co | 0.100 | Al | 0.050 | Amorphous | 1.2 | 1.52 | 23.1 | 8.2 | 7.5 | 0.93 | 33 |
| 111 | Example | Co | 0.100 | Zn | 0.050 | Amorphous | 1.2 | 1.52 | 23.1 | 8.4 | 7.5 | 0.91 | 34 |
| 112 | Example | Co | 0.100 | Sn | 0.050 | Amorphous | 1.3 | 1.52 | 23.6 | 8.3 | 7.5 | 0.91 | 34 |
| 113 | Example | Co | 0.100 | Cu | 0.050 | Amorphous | 1.2 | 1.52 | 23.4 | 8.5 | 7.3 | 0.92 | 33 |
| 114 | Example | Co | 0.100 | Cr | 0.050 | Amorphous | 1.2 | 1.51 | 23.7 | 8.2 | 7.4 | 0.92 | 33 |
| 115 | Example | Co | 0.100 | Bi | 0.050 | Amorphous | 1.2 | 1.52 | 23.9 | 8.4 | 7.5 | 0.93 | 34 |
| 116 | Example | Co | 0.100 | La | 0.050 | Amorphous | 1.4 | 1.53 | 23.7 | 8.5 | 7.5 | 0.93 | 34 |
| 117 | Example | Co | 0.100 | Y | 0.050 | Amorphous | 1.5 | 1.51 | 24.7 | 8.4 | 7.6 | 0.92 | 33 |
| 118 | Example | Ni | 0.100 | Al | 0.050 | Amorphous | 0.9 | 1.43 | 24.3 | 8.5 | 7.3 | 0.94 | 34 |
| 119 | Example | Ni | 0.100 | Zn | 0.050 | Amorphous | 0.9 | 1.43 | 24.5 | 8.3 | 7.5 | 0.91 | 35 |
| 120 | Example | Ni | 0.100 | Sn | 0.050 | Amorphous | 1.1 | 1.43 | 24.1 | 8.2 | 7.5 | 0.92 | 34 |
| 121 | Example | Ni | 0.100 | Cu | 0.050 | Amorphous | 1.0 | 1.42 | 24.2 | 8.3 | 7.8 | 0.91 | 34 |
| 122 | Example | Ni | 0.100 | Cr | 0.050 | Amorphous | 0.9 | 1.43 | 24.8 | 8.5 | 7.8 | 0.93 | 34 |
| 123 | Example | Ni | 0.100 | Bi | 0.050 | Amorphous | 0.9 | 1.44 | 25.1 | 8.2 | 7.5 | 0.93 | 35 |
| 124 | Example | Ni | 0.100 | La | 0.050 | Amorphous | 1.1 | 1.43 | 23.4 | 8.1 | 7.5 | 0.94 | 34 |
| 125 | Example | Ni | 0.100 | Y | 0.050 | Amorphous | 1.1 | 1.43 | 23.5 | 8.4 | 7.6 | 0.92 | 34 |

According to Table 4, the soft magnetic alloy powders of Sample No. 71 to 125 having the compositions which satisfied the ranges of the present invention exhibited good HcJ, Bs, and σ. Further, μ of the toroidal core using the soft magnetic alloy powder was good.

### (Experiment 4)

In Experiment 4, the soft magnetic alloy powders of Sample No. 126 to 128 were produced under the same conditions as Experiment 3 expect for changing a powder feed amount per one sieving process from that of Sample No. 71 in order to change the number-based average circularity of the soft magnetic alloy powder. Results are shown in Table 5. Note that, Table 5 shows specific values of the number-based average circularity of the particle sizes 25 μm or more to 30 μm or less.

In Experiment 4, a voltage resistance property was measured together with the permeability of the toroidal core. For measuring the voltage resistance property, first, In—Ga electrodes were formed to two surfaces perpendicular to a thickness direction of the toroidal core. Next, voltage was applied using a source meter, and the voltage when 1 mA current flew was measured. Then, the voltage resistance property was measured by dividing this voltage with a thickness of the toroidal core.

TABLE 5

| | | | | Soft magnetic alloy powder | | | | | | | | |
|---|---|---|---|---|---|---|---|---|---|---|---|---|
| | | | | | | | Number-based | | | | | |
| | | | | | | Volume- | | | Average | Average | | |
| | Example/ | Powder | Classifi- | | | based | | | circularity | circularity | Toroidal core | |
| | Com- | feed | cation | | | D50 | | | of r or more | of 25 μm or | perme- | Voltage |
| Sample | parative | amount/ | time/ | | HcJ/ | (r)/ | D50/ | σ/ | and 2r | more and 30 | ability | resistance |
| No. | example | kg | min | XRD | Oe | μm | μm | μm | or less | μm or less | μ | V/mm |
| 71 | Example | 0.05 | 5 | Amorphous | 0.8 | 24.0 | 8.5 | 7.4 | 0.93 | 0.94 | 35 | 434 |
| 126 | Example | 1.0 | 5 | Amorphous | 0.7 | 24.1 | 8.3 | 7.3 | 0.85 | 0.90 | 34 | 345 |
| 127 | Example | 1.0 | 5 | Amorphous | 0.8 | 24.3 | 8.2 | 7.3 | 0.83 | 0.85 | 33 | 285 |
| 128 | Example | 2.0 | 5 | Amorphous | 0.8 | 24.2 | 8.1 | 7.4 | 0.70 | 0.74 | 33 | 156 |

According to Table 5, the soft magnetic alloy powders of Sample No. 126 to 128, in which the average circularity, was varied exhibited good HcJ and σ as similar to Sample No. 71. Further, μ of the toroidal core using the soft magnetic alloy powder was good.

Also, the voltage resistance property of the toroidal core tended to show better results as the average circularity of r or more and 2r or less increased and the average circularity of 25 μm or more to 30 μm or less increased.

### (Experiment 5)

In Experiment 5, the soft magnetic alloy powders of Sample No. 130 to 136 were produced under the same conditions as Experiment 1 except that the powder feed amount per one sieving process and the sieving time were changed from those of Sample No. 8 in order to change the average circularity of the soft magnetic alloy powder. Also, as similar to Experiment 4, a permeability and a voltage resistance property of the toroidal core using each soft magnetic alloy powder of Sample No. 130 to 136 were measured. Results are shown in Table 6. Note that, Table 6 shows specific values of the number-based average circularity of the particle sizes 25 μm or more to 30 μm or less; and specific values of the number-based average circularity of the particle sizes 5 μm or more to 10 μm or less.

TABLE 6

| | | | | Soft magnetic alloy powder | | | | | | | | | |
|---|---|---|---|---|---|---|---|---|---|---|---|---|---|
| | | | | | | | Number-based | | | | | | |
| | | | | | | Volume- | | | Average | Average | Average | | |
| | Example/ | Powder | Classifi- | | | based | | | circularity | circularity | circularity | Toroidal core | |
| | Com- | feed | cation | | | D50 | | | of r or more | of 25 μm or | of 5 μm or | Perme- | Voltage |
| Sample | parative | amount/ | time/ | | HcJ/ | (r)/ | D50/ | σ/ | and 2r or | more and 30 | more and 10 | ability | resistance |
| No. | example | kg | min | XRD | Oe | μm | μm | μm | less | μm or less | μm or less | μ | V/mm |
| 130 | Example | 0.05 | 1 | Amrophous | 1.8 | 10.6 | 4.5 | 2.8 | 0.93 | 0.94 | 0.94 | 33 | 345 |
| 131 | Example | 0.1 | 1 | Amrophous | 1.7 | 10.3 | 4.3 | 2.6 | 0.83 | 0.85 | 0.92 | 32 | 245 |
| 132 | Example | 0.1 | 5 | Amrophous | 1.9 | 10.7 | 4.3 | 2.7 | 0.85 | 0.90 | 0.93 | 32 | 245 |
| 8 | Example | 0.5 | 1 | Amrophous | 1.8 | 10.6 | 4.3 | 2.8 | 0.84 | 0.82 | 0.85 | 30 | 235 |
| 133 | Example | 1.0 | 1 | Amrophous | 1.8 | 10.4 | 4.5 | 2.8 | 0.70 | 0.74 | 0.82 | 31 | 145 |
| 134 | Example | 2.0 | 1 | Amrophous | 1.6 | 10.4 | 4.1 | 2.3 | 0.65 | 0.62 | 0.62 | 28 | 98 |
| 135 | Example | 2.0 | 3 | Amrophous | 1.9 | 10.4 | 4.5 | 2.8 | 0.65 | 0.62 | 0.83 | 30 | 111 |
| 136 | Example | 2.0 | 5 | Amrophous | 1.7 | 10.4 | 4.1 | 2.3 | 0.65 | 0.63 | 0.93 | 29 | 100 |

According to Table 6, the soft magnetic alloy powders of Sample No. 8, and 130 to 136, in which average circularities of the soft magnetic alloy powders varied, exhibited good HcJ and σ as similar to the examples of Experiment 1. Further, μ of the toroidal core using the soft magnetic alloy powder was good.

Also, the voltage resistance property of the toroidal core tended to show better results as the average circularity of r or more and 2r or less increased and the average circularity of 25 μm or more to 30 μm or less increased.

### (Experiment 6)

In Experiment 6, six Samples A to F having different particle sizes and shapes were produced by varying a gas spraying pressure of a gas atomization within a range of 2 MPa or more and 15 MPa or less. Then, Sample No. 71, 137, 138 were produced by blending Samples A to F. Regarding Sample No. 137 and 138, the number-based average circularity of the particles having the particle sizes of r or more and 2r or less and the number-based average circularity of the particle sizes of 25 μm or more to 30 μm or less were made close to the values of Sample No. 71; and the average circularity of the particles of the soft magnetic alloy powder as a whole was varied. Table 7B shows the gas spraying pressure used in Samples A to F, the number-based D50, and the average circularity of the particles of the soft magnetic alloy powder as a whole. Table 7C shows the blending ratio (mass ratio) of Samples A to F. Note that, Sample C is the same as Sample No. 71, and Samples A to F were produced under the same conditions as Sample No. 71 except for the gas spraying pressure of a gas atomization of Samples A to F. Further, a permeability and a voltage resistance property of the toroidal core using the soft magnetic alloy powder of each sample were measured. Results are shown in Table 7A.

TABLE 7A

| | | Soft magnetic alloy powder | | | | | | | | | |
|---|---|---|---|---|---|---|---|---|---|---|---|
| | | | | | number-based | | | | | | |
| | | | | Volume- | | | Average | Average | Average | | |
| | Example/ | | | based | | | circularity | circularity | circularity | Toroidal core | |
| | Com- | | | D50 | | | of r or more | of 25 μm or | of particles | Perme- | Voltage |
| Sample | parative | | HcJ/ | (r)/ | D50/ | σ/ | and 2r or | more and 30 | as a | ability | resistance |
| No. | example | XRD | Oe | μm | μm | μm | less | μm or less | whole | μ | V/mm |
| 71 | Example | Amorphous | 0.8 | 24.0 | 8.5 | 7.4 | 0.93 | 0.93 | 0.95 | 33 | 434 |
| 137 | Example | Amorphous | 0.9 | 23.1 | 8.6 | 7.3 | 0.91 | 0.93 | 0.85 | 33 | 421 |
| 138 | Example | Amorphous | 0.8 | 22.5 | 8.2 | 7.2 | 0.90 | 0.93 | 0.70 | 33 | 432 |

TABLE 7B

| | | Number- | |
|---|---|---|---|
| | Gas spraying | based | |
| | pressure | D50 | Number-based |
| | /MPa | /μm | circularity |
| Sample A | 2 | 24.0 | 0.97 |
| Sample B | 5 | 10.3 | 0.96 |
| Sample C | 7 | 8.5 | 0.95 |
| Sample D | 10 | 6.7 | 0.83 |
| Sample E | 12 | 4.4 | 0.75 |
| Sample F | 15 | 2.3 | 0.60 |

TABLE 7C

| Type | Mixing ratio | | | | | |
|---|---|---|---|---|---|---|
| of | Sample | Sample | Sample | Sample | Sample | Sample |
| Sample | A | B | C | D | E | F |
| Sample | 0 | 0 | 100 | 0 | 0 | 0 |
| No. 71 | | | | | | |
| Sample | 15 | 10 | 25 | 10 | 20 | 20 |
| No. 137 | | | | | | |
| Sample | 30 | 0 | 0 | 0 | 0 | 70 |
| No. 138 | | | | | | |

According to Table 7A, even when the average circularity of the particles as a whole was varied, a good result as same as prior to the change can be obtained as long as the composition, the number-based average circularity of r or more and 2r or less, and the number-based average circularity of 25 μm or more to 30 μm or less were high values.

### (Experiment 7)

In Experiment 7, the soft magnetic alloy powders of Sample No. 139, 139a, 140, and 140a were produced under the same conditions except that P content (c) and Si content (d) were varied from those of Sample No. 71. Results are shown in Table 8.

TABLE 8

| | | Fe_{(1-(a+b+c+d+e+f))}MₐB_{b}P_{c}Si_{d}CₑS_{f} (α = β = 0) | | | | | | | | |
|---|---|---|---|---|---|---|---|---|---|---|
| | Example/ | | | | | | | | M + B + P + | |
| Sample | Comparative | | M(Nb) | B | P | Si | C | S | Si + C | C + S |
| No. | example | Fe | a | b | c | d | e | f | a + b + c + d + e | e + f |
| 139 | Example | 0 749 | 0.000 | 0.120 | 0.040 | 0.080 | 0.010 | 0.0010 | 0.250 | 0.011 |
| 139a | Example | 0.749 | 0.000 | 0.120 | 0.035 | 0.085 | 0.010 | 0.0010 | 0.250 | 0.011 |
| 71 | Example | 0.749 | 0.000 | 0.120 | 0.030 | 0.090 | 0.010 | 0.0010 | 0.250 | 0.011 |
| 140a | Example | 0.749 | 0.000 | 0.120 | 0.025 | 0.095 | 0.010 | 0.0010 | 0.250 | 0.011 |
| 140 | Example | 0.749 | 0.000 | 0.120 | 0.020 | 0.100 | 0.010 | 0.0010 | 0.250 | 0.011 |

| | Soft magnetic alloy powder | | | | | | | |
|---|---|---|---|---|---|---|---|---|
| | | | | Number-based | | | | |
| | | | Volume- | | | Average | Toroidal core | |
| | | | based | | | circularity of r or | | Voltage |
| Sample | | | D50 | | | more and 2r or | Permeability | resistance |
| No. | XRD | HcJ/Oe | (r)/μm | D50/μm | σ/μm | less | μ | V/mm |
| 139 | Amorphous | 1.2 | 24.1 | 8.5 | 7.2 | 0.91 | 34 | 434 |
| 139a | Amorphous | 1.0 | 24.3 | 8.5 | 7.4 | 0.92 | 35 | 422 |
| 71 | Amorphous | 0.8 | 24.0 | 8.5 | 7.4 | 0.93 | 35 | 434 |
| 140a | Amorphous | 1.0 | 24.5 | 8.4 | 7.3 | 0.93 | 35 | 412 |
| 140 | Amorphous | 1.3 | 24.3 | 8.6 | 7.1 | 0.90 | 33 | 427 |

According to Table 8, Sample No. 71, 139a, and 140a satisfying 0.080<d<0.100 exhibited lower HcJ, which was a good HcJ, compared to Sample No. 139 and 140 which did not satisfy 0.080<d<0.100.

### (Experiment 8)

In Experiment 8, the soft magnetic alloy powders of Sample No. 141a, 141 to 143 were produced under the same conditions except that B content (b) and C content (c) were varied from those of Sample No. 71. Results are shown in Table 9.

TABLE 9

| | | Fe_{(1-(a+b+c+d+e+f))}MₐB_{b}P_{c}Si_{d}CₑS_{f} (α = β = 0) | | | | | | | | |
|---|---|---|---|---|---|---|---|---|---|---|
| | Example/ | | | | | | | | M + B + P + | |
| Sample | Comparative | | M(nb) | B | P | Si | C | S | Si + C | C + S |
| No. | example | Fe | a | b | c | d | e | f | a + b + c + d + e | e + f |
| 71 | Example | 0.749 | 0.000 | 0.120 | 0.030 | 0.090 | 0.010 | 0.0010 | 0.250 | 0.011 |
| 141 | Example | 0.749 | 0.000 | 0.100 | 0.030 | 0.090 | 0.030 | 0.0010 | 0.250 | 0.031 |
| 141a | Example | 0.749 | 0.000 | 0.095 | 0.030 | 0.090 | 0.035 | 0.0010 | 0.250 | 0.036 |
| 142 | Example | 0.749 | 0.000 | 0.080 | 0.030 | 0.090 | 0.050 | 0.0010 | 0.250 | 0.051 |
| 143 | Example | 0.749 | 0.000 | 0.060 | 0.030 | 0.090 | 0.070 | 0.0010 | 0.250 | 0.071 |

| | Soft magnetic alloy powder | | | | | | | |
|---|---|---|---|---|---|---|---|---|
| | | | | Number-based | | | | |
| | | | | | | Average | | |
| | | | Volume- | | | circularity | Toroidal core | |
| | | | based | | | of r or | | Voltage |
| Sample | | | D50 | | | more and | Permebility | resistance |
| No. | XRD | HcJ/Oe | (r)/μm | D50/μm | σ/μm | 2r or less | μ | V/mm |
| 71 | Amorphous | 0.8 | 24.0 | 8.5 | 7.4 | 0.93 | 35 | 434 |
| 141 | Amorphous | 0.8 | 24.0 | 8.5 | 7.6 | 0.94 | 36 | 421 |
| 141a | Amorphous | 0.9 | 24.2 | 8.4 | 7.5 | 0.94 | 36 | 423 |
| 142 | Amorphous | 0.8 | 24.2 | 8.3 | 7.6 | 0.95 | 37 | 444 |
| 143 | Amorphous | 0.9 | 24.1 | 8.4 | 7.2 | 0.93 | 34 | 451 |

According to Table 9, Sample No. 71, 141a, 141, and 142 satisfying 0.0001≤e+f≤0.051 had a larger a and a permeability μ of the toroidal core was larger compared to Sample No. 143 which did not satisfy 0.0001≤e+f≤0.051.

According to Table 9, Sample No. 141a and 142 satisfying 0.030<e≤0.050 had a larger permeability p of the toroidal core compared to Sample No. 71, 141, and 143 which did not satisfy 0.030<e≤0.050.

### (Experiment 9)

In Experiment 9, the soft magnetic alloy powder of Sample No. 151 was produced by carrying out the heat treatment to the soft magnetic alloy powder of Sample No. 59 to precipitate nanocrystals in the soft magnetic alloy powder. A heat treatment condition was 520° C. for 60 minutes. It was confirmed that nanocrystal particles having a crystal structure of bcc and crystal particle sizes of 30 nm or less were precipitated in the soft magnetic alloy powder of Sample No. 151. Also, it was confirmed using XRD that an amorphous ratio X (%) of the soft magnetic alloy powder of Sample No. 151 was 85% or more. Results are shown in Table 10.

TABLE 10

| | | Soft magnetic alloy powder | | | | | | |
|---|---|---|---|---|---|---|---|---|
| | | | | | Number-based | | | Toroidal |
| | | | | Volume- | | | Average | core |
| | Example/ | | | based | | | circularity of r or | Perme- |
| Sample | Comparative | | HcJ/ | D50 (r)/ | D50/ | σ/ | more and 2r or | ability |
| No. | example | XRD | Oe | μm | μm | μm | [symbol] | μ |
| 59 | Example | Amorphous | 0.9 | 24.3 | 8.5 | 7.3 | 0.93 | 35 |
| 151 | Example | Amorphous including | 0.7 | 24.3 | 8.5 | 7.3 | 0.93 | 38 |
| | | nanocrystals | | | | | | |

[symbol]

indicates data missing or illegible when filed

According to Table 10, Sample No. 151 in which nano crystal particles were precipitated by heat treatment had decreased HcJ and increased permeability μ of the toroidal core compared to Sample No. 59 which was before the heat treatment.

### NUMERICAL REFERENCES

1 . . . Measurement results of particle shape
2 . . . Atomization apparatus
20 . . . Molten metal supplier
21 . . . Molten metal
21a . . . Molten metal drop
30 . . . Cooling part
36 . . . Coolant introducing part
38al . . . Outer projection
50 . . . Coolant flow

1. A soft magnetic alloy powder represented by a compositional formula (Fe_{(1-(α+β))}X1_{α}X2_{β})_{(1-(a+b+c+d+e+f))}MₐB_{b}P_{c}Si_{d}CₑS_{f}, wherein
X1 is one or more selected from the group consisting of Co and Ni;
X2 is one or more selected from the group consisting of Al, Mn, Ag, Zn, Sn, As, Sb, Cu, Cr, Bi, N, O, and rare earth elements;
M represents one or more selected from the group consisting of Nb, Hf, Zr, Ta, Mo, W, Ti, and V;
0≤a≤0.150,
0≤b≤0.200,
0≤c≤0.200,
0≤d≤0.200,
0<e≤0.200,
0<f≤0.0200,
0.100≤a+b+c+d+e≤0.300,
0.0001≤e+f≤0.220,
α≤0,
β≥0, and
0≤α+β≤0.50 are satisfied; and
an amorphous ratio (X) represented by a below formula (1) satisfies 85% or more.
X=100−(Ic/(Ic+Ia))×100 (1)
Ic: Crystal scattering integrated intensity
Ia: Amorphous scattering integrated intensity

2. The soft magnetic alloy powder according to claim 1, wherein
D50 of a volume-based particle size distribution is represented by r, and soft magnetic alloy particles having particle sizes of r or more and 2r or less of the soft magnetic alloy powder have an average circularity of 0.70 or more.

3. The soft magnetic alloy powder according to claim 1, wherein
D50 of a volume-based particle size distribution is represented by r, and soft magnetic alloy particles having particle sizes of r or more and 2r or less of the soft magnetic alloy powder have an average circularity of 0.90 or more.

4. The soft magnetic alloy powder according to claim 1, wherein soft magnetic alloy particles having particle sizes of 25 μm or more and 30 μm or less of the soft magnetic alloy powder have an average circularity of 0.70 or more.

5. The soft magnetic alloy powder according to claim 1, wherein soft magnetic alloy particles having particle sizes of 25 μm or more and 30 μm or less of the soft magnetic alloy powder have an average circularity of 0.90 or more.

6. The soft magnetic alloy powder according to claim 1, wherein soft magnetic alloy particles having particle sizes of 5 μm or more and 10 μm or less of the soft magnetic alloy powder have an average circularity of 0.70 or more.

7. The soft magnetic alloy powder according to claim 1, wherein soft magnetic alloy particles having particle sizes of 5 μm or more and 10 μm or less of the soft magnetic alloy powder have an average circularity of 0.90 or more.

8. The soft magnetic alloy powder according to claim 1, wherein 0.0001≤e+f≤0.051 is satisfied.

9. The soft magnetic alloy powder according to claim 1, wherein 0.080<d<0.100 is satisfied.

10. The soft magnetic alloy powder according to claim 1, wherein 0.030<e≤0.050 is satisfied.

11. The soft magnetic alloy powder according to claim 1, wherein 0≤a<0.020 is satisfied.

12. The soft magnetic alloy powder according to claim 1, wherein the soft magnetic alloy powder comprises nanocrystal particles.

13. A dust core including the soft magnetic alloy powder according to claim 1.

14. A magnetic component including the soft magnetic alloy powder according to claim 1.

15. An electronic device including the soft magnetic alloy powder according to claim 1.
